(19) United States
(12) Patent Application Publication
(10) Pub. No.: US 2019/0044666 A1
(43) Pub. Date: Feb. 7, 2019

(54) METHOD AND APPARATUS FOR HANDLING HYBRID AUTOMATIC REPEAT REQUEST (HARQ) FEEDBACK FOR MULTIPLE TRANSMISSION/RECEPTION POINTS (TRP) IN A WIRELESS COMMUNICATION SYSTEM

(71) Applicant: ASUSTek Computer Inc., Taipei City (TW)

(72) Inventor: Ming-Che Li, Taipei City (TW)

(21) Appl. No.: 16/054,695

(22) Filed: Aug. 3, 2018

Related U.S. Application Data
(60) Provisional application No. 62/540,707, filed on Aug. 3, 2017.

(51) Int. Cl. H04L 1/18; H04W 72/04; H04W 48/04

(52) U.S. Cl. CPC H04L 1/1861; H04W 72/0446; H04L 1/1854; H04W 48/04; H04L 1/1812; H04W 72/042

(57) ABSTRACT

A method and apparatus are disclosed from the perspective of a User Equipment (UE). In one embodiment, the method includes the UE receiving a DL (Downlink) transmission in a TTI (Transmission Time Interval) in one serving cell. The method also includes the UE generating at least two feedback bits associated to separate layers of the DL transmission. Furthermore, the method includes the UE performing bundling across the at least two feedback bits if the separate layers of the DL transmission are transmitted from a same TRP (Transmission/Reception Point). In addition, the method includes the UE not performing bundling across the at least two feedback bits if the separate layers of the DL transmission are transmitted from separate TRPs.

### CROSS-REFERENCE TO RELATED APPLICATIONS

The present application claims the benefit of U.S. Provisional Patent Application Ser. No. 62/540,707 filed on Aug. 3, 2017, the entire disclosure of which is incorporated herein in its entirety by reference.

### FIELD

This disclosure generally relates to wireless communication networks, and more particularly, to a method and apparatus for handling HARQ feedback for multiple TRP in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

A method and apparatus are disclosed from the perspective of a User Equipment (UE). In one embodiment, the method includes the UE receiving a DL (Downlink) transmission in a TTI (Transmission Time Interval) in one serving cell. The method also includes the UE generating at least two feedback bits associated to separate layers of the DL transmission. Furthermore, the method includes the UE performing bundling across the at least two feedback bits if the separate layers of the DL transmission are transmitted from a same TRP (Transmission/Reception Point). In addition, the method includes the UE not performing bundling across the at least two feedback bits if the separate layers of the DL transmission are transmitted from separate TRPs.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a diagram according to one exemplary embodiment.

FIG. 6 is a diagram according to one exemplary embodiment.

FIG. 7 is a diagram according to one exemplary embodiment.

FIG. 8 is a diagram according to one exemplary embodiment.

FIG. 9 is a diagram according to one exemplary embodiment.

FIG. 10 is a diagram according to one exemplary embodiment.

FIG. 11 is a diagram according to one exemplary embodiment.

FIG. 12 is a diagram according to one exemplary embodiment.

FIG. 13 is a reproduction of Table 5.2-1 and Table 5.2-2 of KT 5G-SIG TS 5G.213 v1.9.

FIG. 14 is a reproduction of Table 5.2-3 of KT 5G-SIG TS 5G.213 v1.9.

FIG. 15 is a reproduction of Table 8.3.3.1-1 of KT 5G-SIG TS 5G.213 v1.9.

FIG. 16 is a reproduction of Table 8.4.3.1-1 of KT 5G-SIG TS 5G.213 v1.9.

FIG. 17 is a reproduction of Table 8.4.3.2-1 of KT 5G-SIG TS 5G.213 v1.9.

FIG. 18 is a diagram according to one exemplary embodiment.

FIG. 19 is a diagram according to one exemplary embodiment.

FIG. 20 is a diagram according to one exemplary embodiment.

FIG. 21 is a flow chart according to one exemplary embodiment.

FIG. 22 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio), or some other modulation techniques.

In particular, the exemplary wireless communication systems and devices described below may be designed to support one or more standards such as the standards offered by a consortium named “3rd Generation Partnership Project” referred to herein as 3GPP, including: R2-162366, “Beam Forming Impacts”, Nokia and Alcatel-Lucent; R2-163716, “Discussion on terminology of beamforming based high frequency NR”, Samsung; R2-162709, “Beam support in NR”, Intel; R2-162762, “Active Mode Mobility in NR: SINR drops in higher frequencies”, Ericsson; R3-160947, TR 38.801 V0.1.0, “Study on New Radio Access Technology; Radio Access Architecture and Interfaces”; R2-164306, “Summary of email discussion [93bis#23][NR] Deployment scenarios”, NTT DOCOMO; 3GPP RAN2#94 meeting minute; R2-162251, “RAN2 aspects of high frequency New RAT”, Samsung; R2-163879, “RAN2 Impacts in HF-NR”, MediaTeK; R2-162210, “Beam level management <-> Cell level mobility”, Samsung; R2-163471, “Cell concept in NR”, CATT; R1-1709881, “Report of RAN1#89 meeting”, ETSI; Draft_Minutes_report_RAN1#AH_NR2_v010; and TS 36.213 V14.2.0, “E-UTRA Physical layer procedures (Release 14)”.

Furthermore, the exemplary wireless communication systems and devices described below may be designed to support one or more standards such the standards offered by a consortium named “KT PyeongChang 5G Special Interest Group” referred to herein as KT 5G-SIG, including: TS 5G.213 v1.9, “KT 5G Physical layer procedures (Release 1)”; TS 5G.321 v1.2, “KT 5G MAC protocol specification (Release 1)”; TS 5G.211 v2.6, “KT 5G Physical channels and modulation (Release 1)”; and TS 5G.331 v1.0, “KT 5G Radio Resource Control (RRC) Protocol specification (Release 1)”.

The standards and documents listed above are hereby expressly incorporated by reference in their entirety.

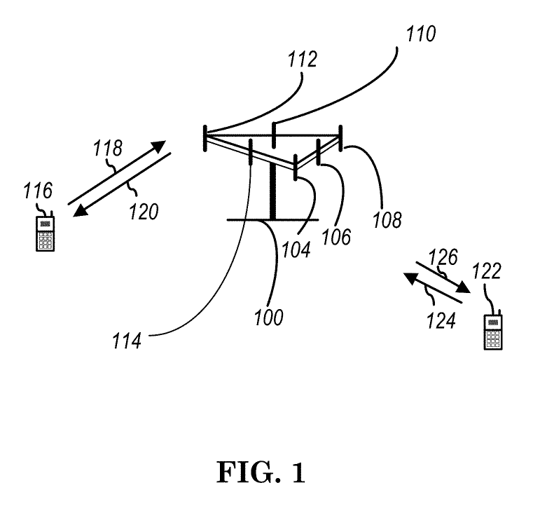

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), or some other terminology. An access terminal (AT) may also be called user equipment (UE), a wireless communication device, terminal, access terminal or some other terminology.

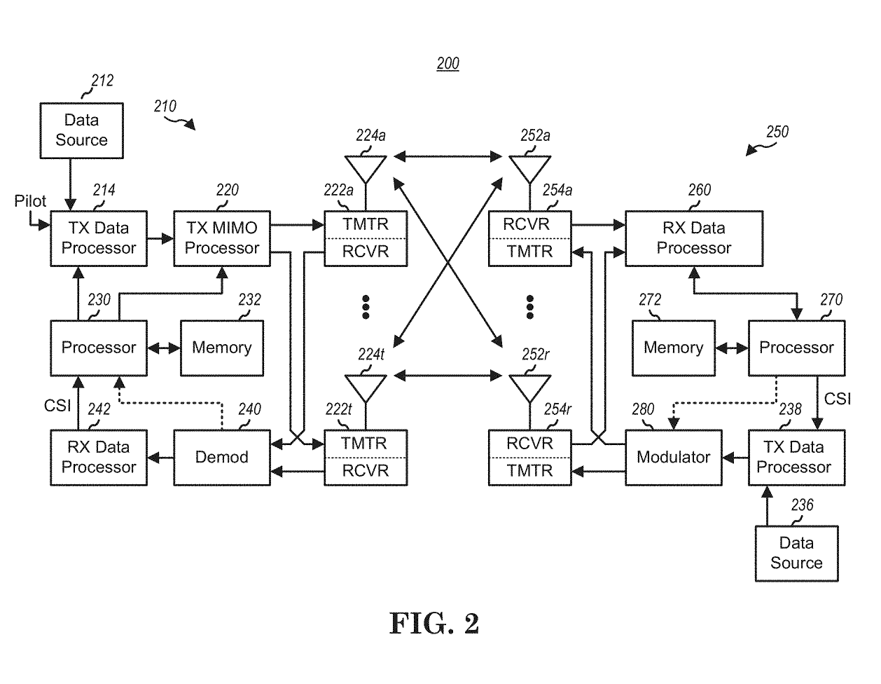

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

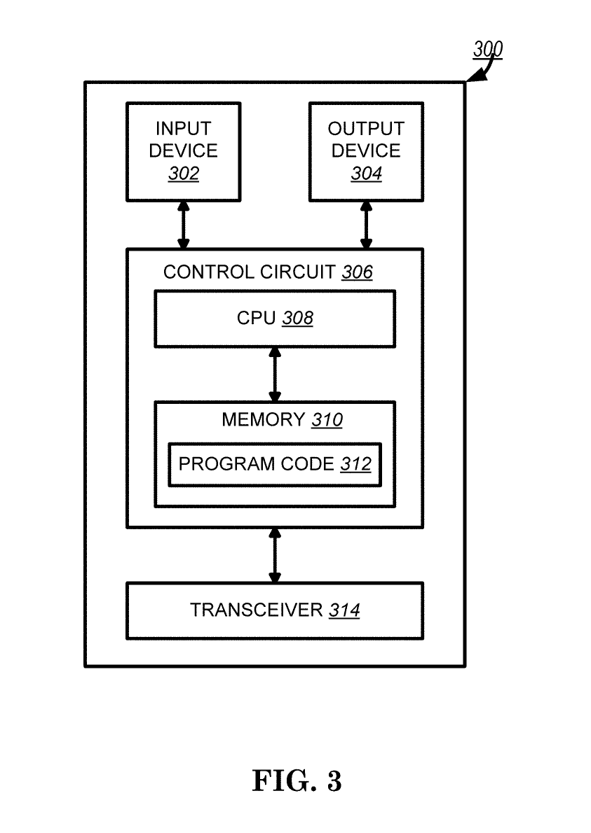

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

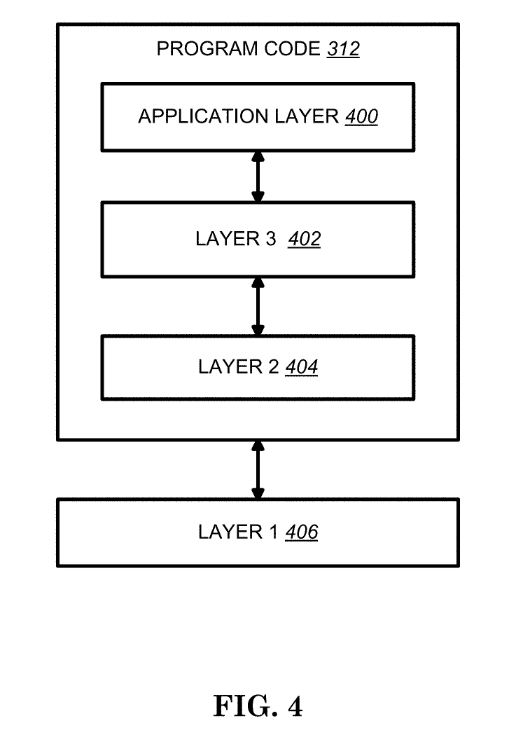

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

3GPP standardization activities on next generation (i.e. 5G) access technology have been launched since March 2015. In general, the next generation access technology aims to support the following three families of usage scenarios for satisfying both the urgent market needs and the more long-term requirements set forth by the ITU-R IMT-2020:

eMBB (enhanced Mobile Broadband)

mMTC (massive Machine Type Communications)

URLLC (Ultra-Reliable and Low Latency Communications).

An objective of the 5G study item on new radio access technology is, in general, to identify and develop technology components needed for new radio systems which should be able to use any spectrum band ranging at least up to 100 GHz. Supporting carrier frequencies up to 100 GHz brings a number of challenges in the area of radio propagation. As the carrier frequency increases, the path loss also increases.

As described in 3GPP R2-162366, in lower frequency bands (e.g. current LTE bands<6 GHz) the required cell coverage may be provided by forming a wide sector beam for transmitting downlink common channels. However, utilizing wide sector beam on higher frequencies (>>6 GHz) the cell coverage is reduced with same antenna gain. Thus, in order to provide required cell coverage on higher frequency bands, higher antenna gain is needed to compensate the increased path loss. To increase the antenna gain over a wide sector beam, larger antenna arrays (number of antenna elements ranging from tens to hundreds) are used to form high gain beams.

As a consequence, the high gain beams are narrow compared to a wide sector beam so multiple beams for transmitting downlink common channels are needed to cover the required cell area. The number of concurrent high gain beams that access point is able to form may be limited by the cost and complexity of the utilized transceiver architecture. In practice, on higher frequencies, the number of concurrent high gain beams is much less than the total number of beams required to cover the cell area. In other words, the access point is able to cover only part of the cell area by using a subset of beams at any given time.

As described in 3GPP R2-163716, beamforming is a signal processing technique used in antenna arrays for directional signal transmission or reception. With beamforming, a beam can be formed by combining elements in a phased array of antennas in such a way that signals at particular angles experience constructive interference while others experience destructive interference. Different beams can be utilized simultaneously using multiple arrays of antennas.

In general, beamforming can be categorized into three types of implementation: digital beamforming, hybrid beamforming, and analog beamforming. For digital beamforming, the beam is generated on the digital domain, i.e. the weighting of each antenna element can be controlled by baseband—e.g. connected to a Transceiver Unit (TXRU). Therefore, it is very easy to tune the beam direction of each subband differently across the system bandwidth. Also, to change beam direction from time to time does not require any switching time between Orthogonal Frequency Division Multiplexing (OFDM) symbols. All beams whose directions cover the whole coverage can be generated simultaneously. However, this structure requires (almost) one-to-one mapping between TXRU (transceiver or Radio Frequency (RF) chain) and antenna element and is quite complicated as the number of antenna element increases and system bandwidth increases (also heat problem exists).

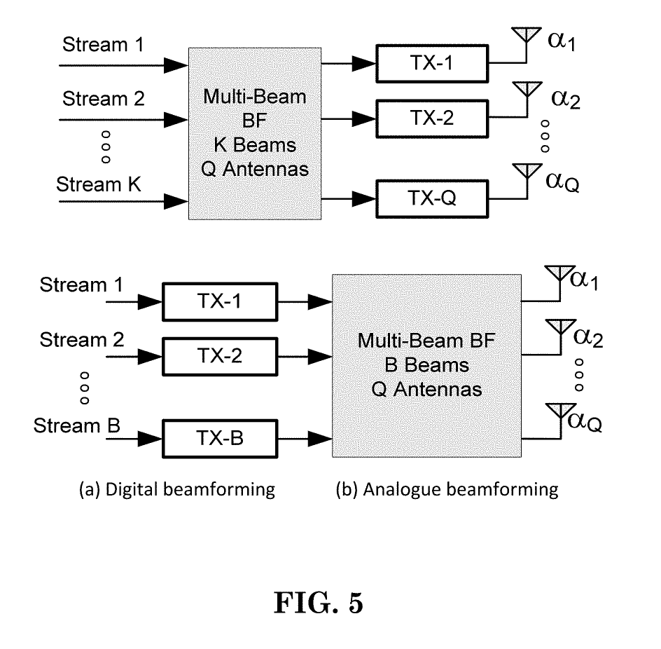

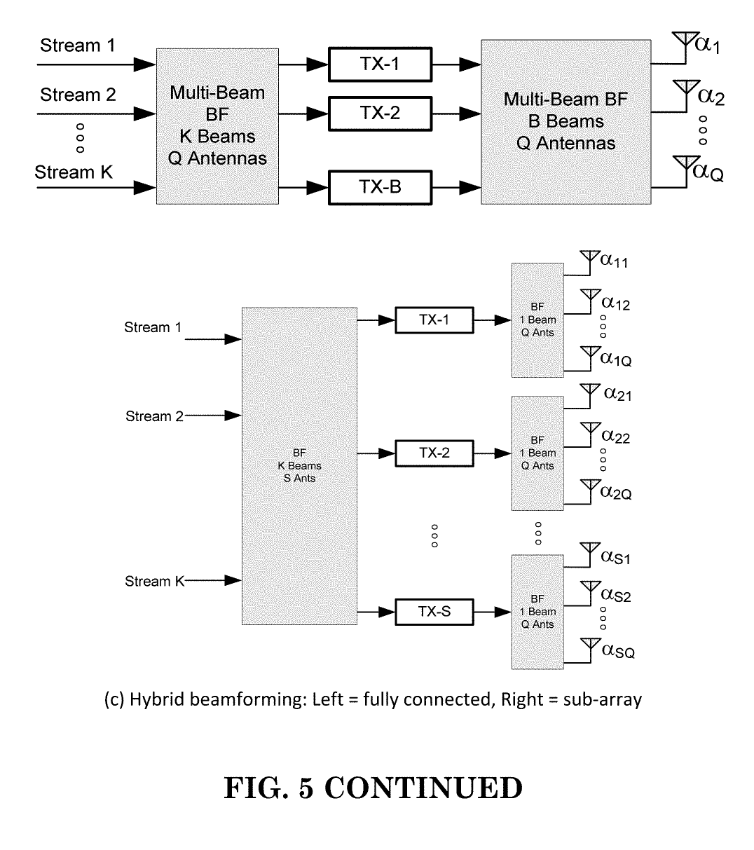

For Analog beamforming, the beam is generated on the analog domain, i.e. the weighting of each antenna element can be controlled by an amplitude/phase shifter in the RF circuit. Since the weighing is purely controlled by the circuit, the same beam direction would apply on the whole system bandwidth. Also, if beam direction is to be changed, switching time is required. The number of beam generated simultaneous by an analog beamforming depends on the number of TXRU. Note that for a given size of array, the increase of TXRU may decrease the antenna element of each beam, such that wider beam would be generated. In short, analog beamforming could avoid the complexity and heat problem of digital beamforming, while is more restricted in operation. Hybrid beamforming can be considered as a compromise between analog and digital beamforming, where the beam can come from both analog and digital domain. FIG. 5 illustrates the three types of beamforming according to one embodiment.

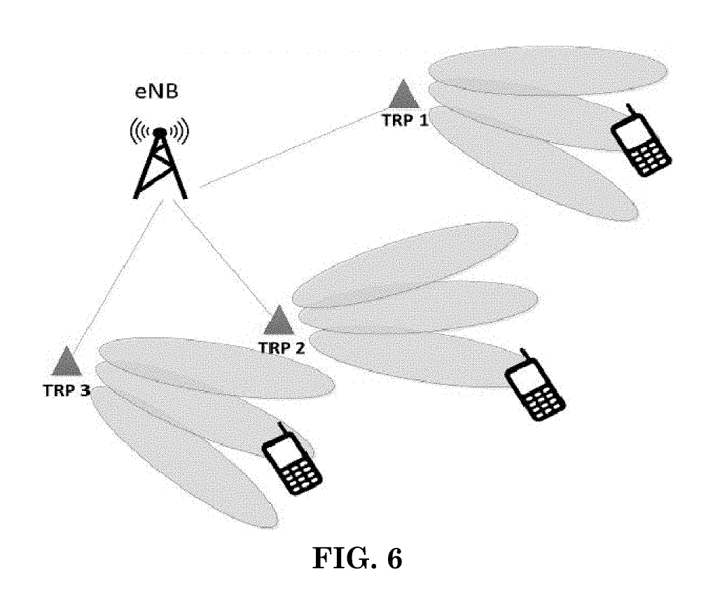

As discussed in 3GPP R2-162709 and as shown in FIG. 6, an eNB (evolved Node B) may have multiple TRPs (either centralized or distributed). Each TRP can form multiple beams. The number of beams and the number of simultaneous beams in the time/frequency domain depend on the number of antenna array elements and the RF at the TRP.

Potential mobility type for NR can be generally listed as follows:

Intra-TRP mobility

Inter-TRP mobility

Inter-NR eNB mobility

As discussed in 3GPP R2-162762, reliability of a system purely relying on beamforming and operating in higher frequencies might be challenging, since the coverage might be more sensitive to both time and space variations. As a consequence of that the SINR (Signal to Noise and Interference ratio) of that narrow link can drop much quicker than in the case of LTE.

Using antenna arrays at access nodes with the number of elements in the hundreds, fairly regular grid-of-beams coverage patterns with tens or hundreds of candidate beams per node may be created. The coverage area of an individual beam from such array may be small, down to the order of some tens of meters in width. As a consequence, channel quality degradation outside the current serving beam area is quicker than in the case of wide area coverage, as provided by LTE.

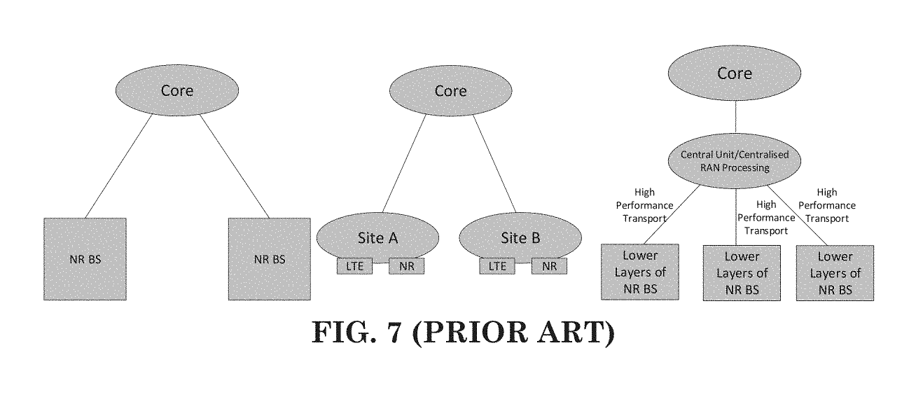

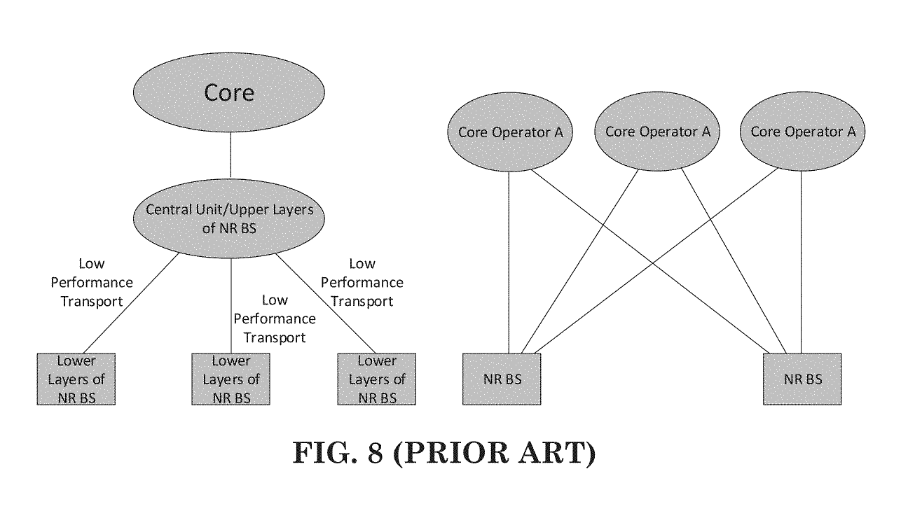

As discussed in 3GPP R3-160947, the exemplary scenarios illustrated in FIGS. 3 and 4 should be considered for support by the NR radio network architecture. FIG. 7 illustrates an architecture with a stand-alone, co-sited with LTE, and centralized baseband. FIG. 8 shows a centralized architecture with low performance transport and shared RAN (Radio Access Network).

As discussed in 3GPP R2-164306, the following scenarios of cell layout for standalone NR are captured to be studied:

Macro cell only deployment

Heterogeneous deployment

Small cell only deployment

As discussed in the 3GPP RAN2#94 Meeting Minutes, 1 NR eNB (e.g. called gNB) corresponds to 1 or many TRPs. Two levels of network controlled mobility includes:

RRC driven at “cell” level.

Zero/Minimum RRC involvement (e.g. at MAC/PHY).

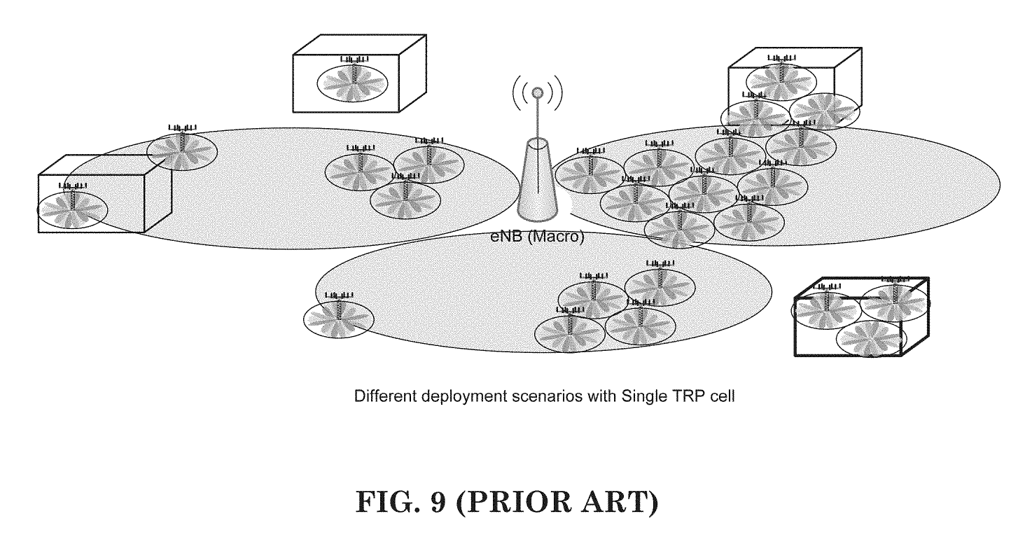

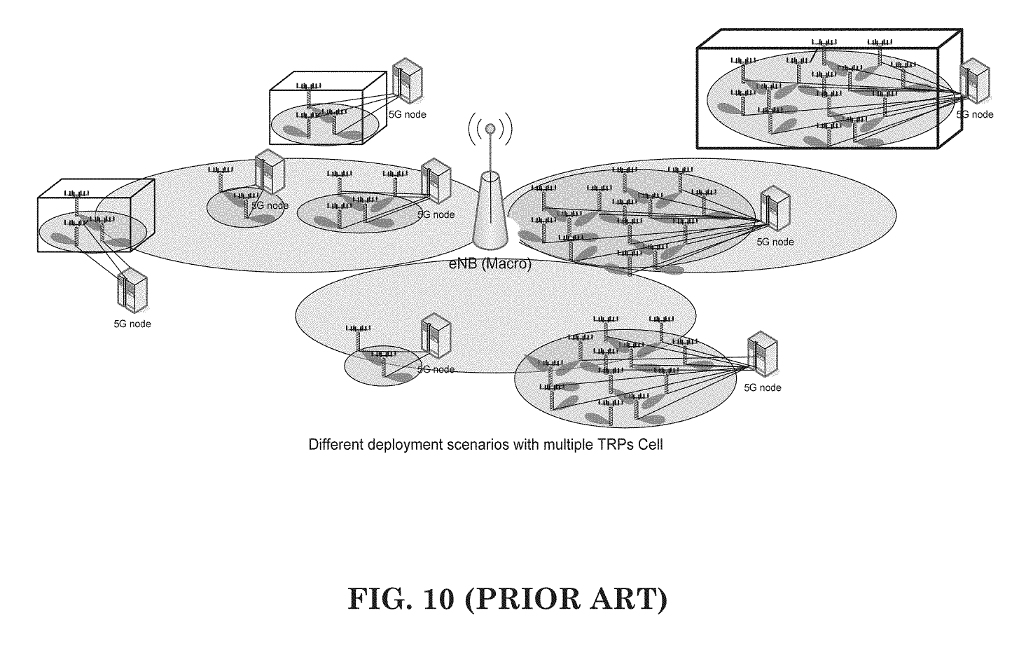

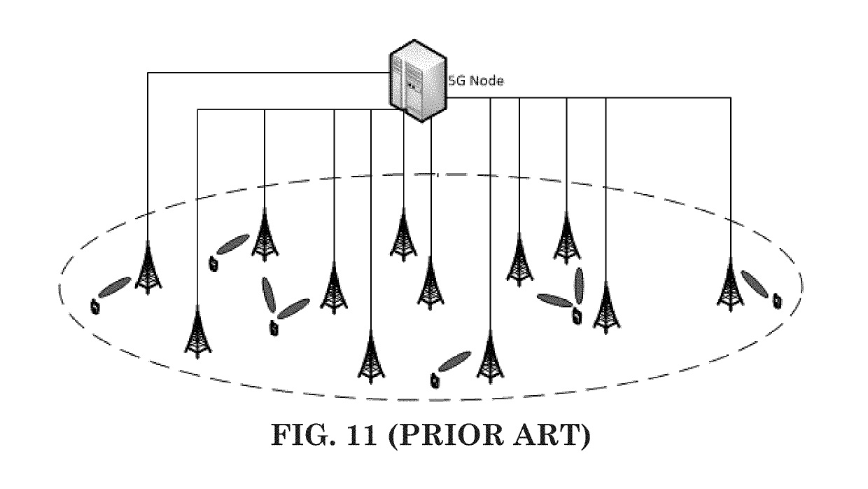

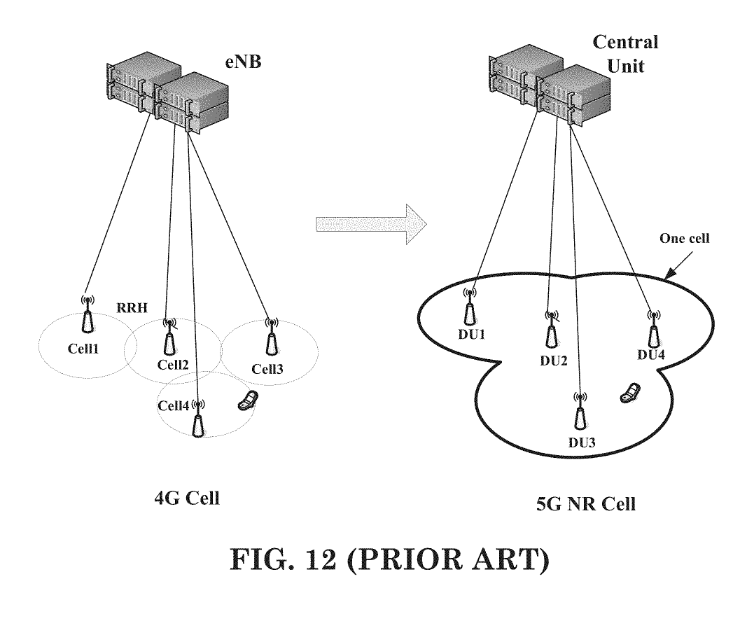

FIGS. 9-12 illustrate some examples of the concept of a cell in 5G NR. FIG. 9 shows a deployment with single TRP cell. FIG. 10 shows a deployment with multiple TRP cell. FIG. 11 shows one 5G cell comprising a 5G node with multiple TRPs. FIG. 12 shows a comparison between a LTE cell and a NR cell.

KT has organized KT PyeongChang 5G Special Interest Group (KT 5G-SIG) to realize the world's first 5G trial service at PyeongChang 2018 Olympic Winter Games. KT had developed a version of 5G common physical layer specification and the higher layer (L2/L3) specification for pushing forward the development of the 5G trial network. Three kinds of beamforming procedures are designed for beamforming-based operation in physical layer, as discussed KT 5G-SIG TS 5G.213 as follows:

### 5 Beamforming Procedures

### 5.1 Beam Acquisition and Tracking

The downlink transmitting beams are acquired from beam reference signals. Up to 8 antenna ports are supported for beam reference signal (BRS). A UE tracks downlink transmitting beams through the periodic BRS measurements. The BRS transmission period is configured by a 2 bit indicator in xPBCH. The BRS transmission period is the necessary time to sweep the whole downlink beams transmitted via BRS.

The following BRS transmission periods are supported:
“00” Single slot (<5 ms): supportable for maximum 7 downlink transmitting beams per antenna port
“01” Single subframe (=5 m): supportable for maximum 14 downlink transmitting beams per antenna port
“10” Two subframe (=10 ms): supportable for maximum 28 downlink transmitting beams per antenna port
“11” Four subframe (=20 ms): supportable for maximum 56 downlink transmitting beams per antenna port

UE maintains a candidate beam set of 4 BRS beams, where for each beam the UE records beam state information (BSI). BSI comprises beam index (BI) and beam reference signal received power (BRSRP).

UE reports BSI on PUCCH or PUSCH as indicated by 5G Node per clause 8.3. 5GNode may send BSI request in DL DCI, UL DCI, and RAR grant.

When reporting BSI on xPUCCH, UE reports BSI for a beam with the highest BRSRP in the candidate beam set.

When reporting BSI on xPUSCH, UE reports BSIs for NE{1,2,4} beams in the candidate beam set, where N is provided in the 2-bit BSI request from 5G Node. The BSI reports are sorted in decreasing order of BRSRP.

### 5.1.1 BRS Management

There are two beam switch procedures, which are MAC-CE based beam switch procedure and DCI based beam switch procedure associated with BRS.

For the MAC-CE based beam switch procedure [4], 5G Node transmits a MAC-CE containing a BI to the UE.

The UE shall, upon receiving the MAC-CE, switch the serving beam at the UE to match the beam indicated by the MAC-CE. The beam switching shall apply from the beginning of subframe n+kbeamswitch-delay-mac where subframe n is used for HARQ-ACK transmission associated with the MAC-CE and kbeamswitch-delay-mac=14. The UE shall assume that the 5G Node beam associated with xPDCCH, xPDSCH, CSI-RS, xPUCCH, xPUSCH, and xSRS is switched to the beam indicated by the MAC-CE from the beginning of subframe n+kbeam-switch-delay-mac.

For the DCI based beam switch procedure, 5G Node requests a BSI report via DCI and the beam_switch_indication field is set to 1 in the same DCI. The UE shall, upon receiving such a DCI, switch the serving beam at the UE to match the beam indicated by the first BI reported by the UE in the BSI report corresponding to this BSI request. The beam swiching shall apply from the beginning of subframe n+kbeam-switch-delay-dic where subframe n is used for sending the BSI report and kbeam-switch-delay-dci=11.

If beam_switch_indication field=0 in the DCI the UE is not required to switch the serving beam at the UE.

For any given subframe, if there is a conflict in selecting the serving beam at the UE, the serving beam is chosen that is associated with the most recently received subframe containing the MAC-CE (for MAC-CE based procedure) or the DCI (for DCI based procedure). A UE is not expected to receive multiple requests for beam switching in the same subframe.

### 5.2 Beam Refinement

BRRS is triggered by DCI. A UE can also request BRRS using SR [4]. To request the serving 5G Node to transmit BRRS, the UE transmits the scheduling request preamble where the higher layer configured preamble resource {u,v,f′, and NSR} is dedicated for beam refinement reference signal initiation request.

The time and frequency resources that can be used by the UE to report Beam Refinement Information (BRI), which consists of BRRS Resource Index (BRRS-RI) and BRRS reference power (BRRS-RP), are controlled by the 5G Node.

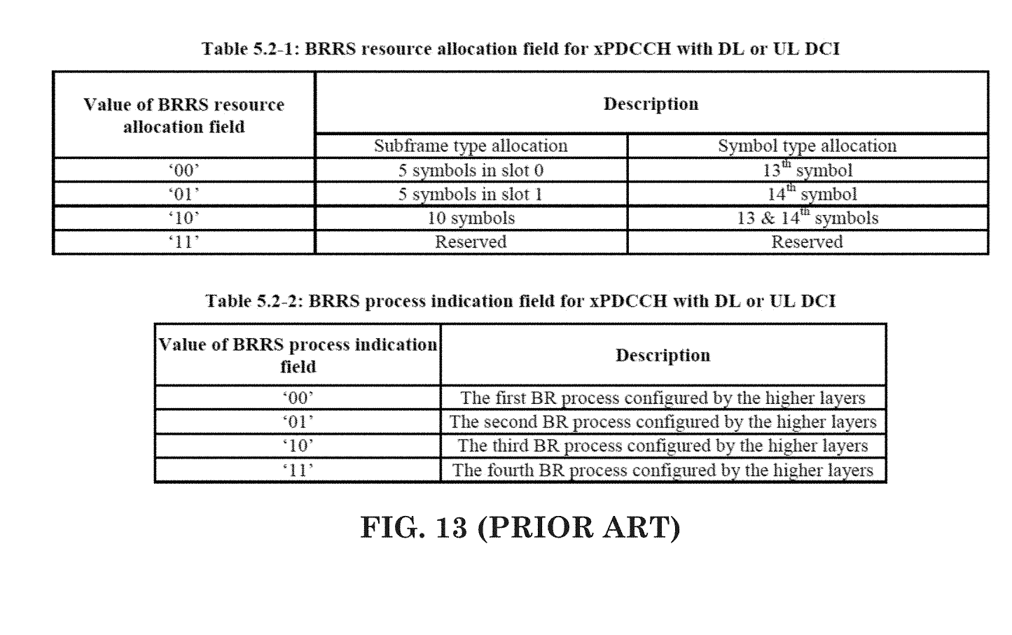

A UE can be configured with 4 Beam Refinement (BR) processes by higher layers. A 2-bit resource allocation field and a 2 bit process indication field in the DCI are described in Table 5.2-1 and Table 5.2-2, respectively.

[Table 5.2-1 entitled “BRRS resource allocation field for xPDCCH with DL or UL DCI” and Table 5.2-2 entitled “BRRS process indication field for xPDCCH with DL or UL DCI” of KT 5G-SIG TS 5G.213 v1.9 are reproduced as FIG. 13]

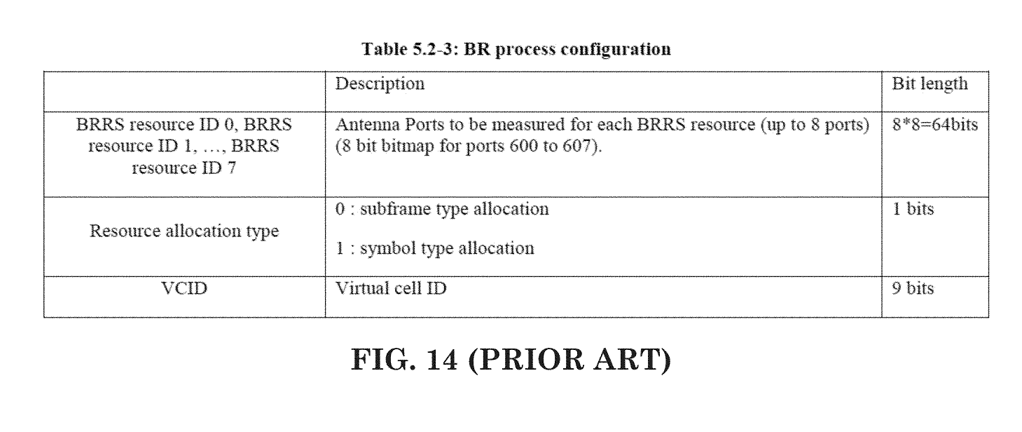

A BR process comprises of up to eight BRRS resources, a resource allocation type and a VCID, and is configured via RRC signalling. A BRRS resource comprises of a set of antenna ports to be measured.

[Table 5.2-3 entitled “BR process configuration” of KT 5G-SIG TS 5G.213 v1.9 is reproduced as FIG. 14]

A BRRS transmission can span 1, 2, 5 or 10 OFDM symbols, and is associated with a BRRS resource allocation, BRRS process indication, and a BR process configuration as in Table 5.2-1, 5.2.-2 and 5.2.-3. A BRI reported by the UE corresponds to one BR process that is associated with up to eight BRRS resources. The UE shall assume that BRRS mapped to the BRRS resource ID 0 in each BRRS process is transmitted by the serving beam.

### 5.2.1 BRRS Management

There are two beam switch procedures, which are MAC-CE based beam switch procedure and DCI based beam switch procedure associated with BRRS.

For the MAC-CE based beam switch procedure [4], 5G Node transmits a MAC-CE containing a BRRS resource ID and the associated BR process ID to the UE.

The UE shall, upon receiving the MAC-CE, switch the serving beam at the UE to match the beam indicated by the MAC-CE. The beam swiching shall apply from the beginning of subframe n+kbeamswitch-delay-mac where subframe n is used for HARQ-ACK transmission associated with the MAC-CE and kbeamswitch-delay-mac=14. The UE shall assume that the 5G Node beam associated with xPDCCH, xPDSCH, CSI-RS, xPUCCH, xPUSCH, and xSRS is switched to the beam indicated by the MAC-CE from the beginning of subframe n+kbeam-switch-delay-mac.

For the DCI based beam switch procedure, 5G Node requests a BRI report via DCI and the beam_switch_indication field is set to 1 in the same DCI. The UE shall, upon receiving such a DCI, switch the serving beam at the UE to match the beam indicated by the first BRRS-RI reported by the UE in the BRI report corresponding to this BRI request. The beam swiching shall apply from the beginning of subframe n+kbeam-switch-delay-dic where subframe n is used for sending the BRI report and kbeam-switch-delay-dci=11.

If beam_switch_indication field=0 in the DCI the UE is not required to switch the serving beam at the UE.

For any given subframe, if there is a conflict in selecting the serving beam at the UE, the serving beam is chosen that is associated with the most recently received subframe containing the MAC-CE (for MAC-CE based procedure) or the DCI (for DCI based procedure). A UE is not expected to receive multiple requests for beam switching in the same subframe.

### 5.3 Beam Recovery

If a UE detects the current serving beam is misaligned [4] and has BSIs for beam recovery, the UE shall perform beam recovery process.

In the UL synchronized UE case, the UE transmits scheduling request by scheduling request preamble where the preamble resource {u, v, f′ and NSR} is dedicated for beam recovery as configured by higher layers. Upon the reception of this request, 5G Node may initiate BSI reporting procedure as described in section 8.3.

In UL asynchronized UE case, the UE transmits random access preamble for contention based random access. If the UE is scheduled by RAR triggering BSI reporting, the UE reports N BSIs in Msg3 as UCI multiplexing in [3].

[symbol]

### 8.3 UE Procedure for Reporting Beam State Information (BSI)

UE reports BSI on xPUCCH or xPUSCH as indicated by 5G Node. 5G Node can send BSI request in DL DCI, UL DCI, and RAR grant.

If a UE receives BSI request in DL DCI, the UE reports a BSI on xPUCCH. The time/frequency resource for xPUCCH is indicated in the DL DCI. When reporting BSI on xPUCCH, UE reports a BSI for a beam with the highest BRSRP in the candidate beam set.

If UE receives BSI request in UL DCI or in RAR grant, UE reports BSIs on xPUSCH. The time/frequency resource for xPUSCH is indicated in the UL DCI or RAR grant that requests BSI report. When reporting BSI on xPUSCH, UE reports BSI for N∈{1,2,4} beams with the highest BRSRP in the candidate beam set, where N is provided in the DCI.

If BSI reporting is indicated on both xPUCCH and xPUSCH in the same subframe, UE reports BSI on xPUSCH only and discards the xPUCCH trigger.

8.3.1 BSI Reporting Using xPUSCH

Upon decoding in subframe n an UL DCI with a BSI request, UE shall report BSI using xPUSCH in subframe n+4+m+l, where parameters m=0 and l={0, 1, . . . 7} is indicated by the UL DCI.

The number of BSIs to report, N∈{1,2,4}, is indicated in UL DCI.

A UE shall report N BSIs corresponding to N beams in the candidate beam set.

A BSI report contains N BIs and corresponding BRSRPs. A UE shall report wideband BRSRPs.

A UE is not expected to receive more than one request for BSI reporting on xPUSCH for a given subframe

8.3.2 BSI Reporting Using xPUCCH

Upon decoding in subframe n a DL DCI with a BSI request, UE shall report BSI using xPUCCH subframe index n+4+m+k, where parameters m=0 and k={0, 1, . . . 7} is indicated by the DL DCI.

When reporting BSI on xPUCCH, UE reports BSI for a beam with the highest BRSRP in the candidate beam set.

A BSI report contains BI and corresponding BRSRP. A UE shall report wideband BRSRP.

A UE is not expected to receive more than one request for BSI reporting on xPUCCH for a given subframe.

### 8.3.3 BSI Definition

### 8.3.3.1 BRSRP Definition

The BRSRP indices and their interpretations are given in Table 8.3.3.1-1. The reporting range of BRSRP is defined from −140 dBm to −44 dBm with 1 dB resolution as shown in Table 8.3.3.1-1.

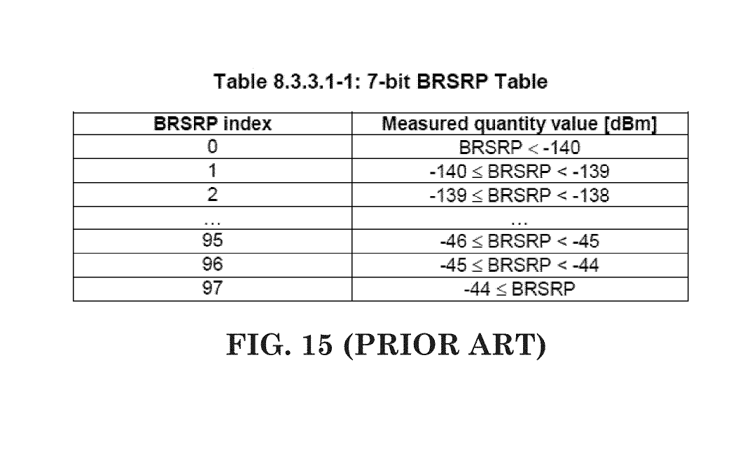

The UE shall derive BRSRP values from the beam measurements based on BRS defined in 5G.211. The UE shall derive BRSRP index from the measured BRSRP value. Each BRSRP index is mapped to its corresponding binary representation using 7 bits.

[Table 8.3.3.1-1, entitled “7-bit BRSRP Table”, of KT 5G-SIG TS 5G.213 v1.9 is reproduced as FIG. 15]

### 8.3.3.2 Beam Index Definition

BI indicates a selected beam index. The BI is the logical beam index associated with antenna port, OFDM symbol index and BRS transmission period [2], which is indicated by 9 bits.

### 8.4 UE Procedure for Reporting Beam Refinement Information (BRI)

8.4.1 BRI Reporting Using xPUSCH

If the uplink DCI in subframe n indicates a BRRS transmission, the BRRS is allocated in subframe n+m where m={0,1,2,3} is indicated by a 2 bit RS allocation timing in the DCI.

A BRI report is associated with one BR process that is indicated in the uplink DCI for the UE. Upon decoding in subframe n an UL DCI with a BRI request, the UE shall report BRI using xPUSCH in subframe n+4+m+1, where parameters m={0, 1, 2, 3} and l={0, 1, . . . 7} are indicated by the UL DCI.

A UE shall report wideband BRRS-RP values and BRRS-RI values corresponding to the best NBRRS BRRS resource ID where NBRRS is configured by higher layers

IF the number of configured BRRS resource ID associated with the BR process is less than or equal to NBRRS then the UE shall report BRRS-RP and BRRS-RI corresponding to all the configured BRRS resources.

A UE is not expected to receive more than one BRI report request for a given subframe.

8.4.2 BRI Reporting Using xPUCCH

IF the DL DCI in subframe n indicates a BRRS transmission, the BRRS is allocated in subframe n+m where m={0,1,2,3} is indicated by the DL DCI.

A BRI report is associated with one BRRS process that is indicated in the downlink DCI for the UE. Upon decoding in subframe n a DL DCI with a BRI request, the UE shall report BRI using xPUCCH in subframe n+4+m+k, where parameters m={0, 1, 2, 3} and k={0, 1, . . . 7} are indicated by the DL DCI.

A UE shall report a wideband BRRS-RP value and a BRRS-RI value corresponding to the best BRRS resource ID.

A UE is not expected to receive more than one BRI report request for a given subframe.

### 8.4.3 BRI Definition

### 8.4.3.1 BRRS-RP Definition

The reporting range of BRRS-RP is defined from −140 dBm to −44 dBm with 1 dB resolution.

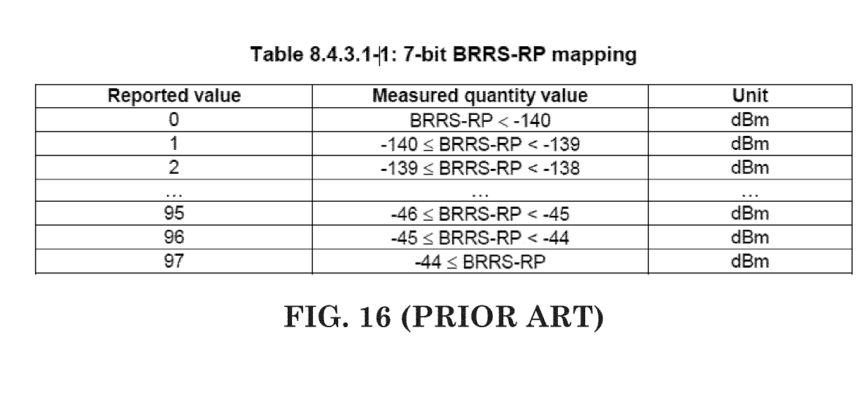

The mapping of BRRS-RP to 7 bits is defined in Table 8.4.3.1-1. Each BRRS-RP index is mapped to its corresponding binary representation using 7 bits.

[Table 8.4.3.1-1, entitled “7-bit BRRS-RP mapping”, of KT 5G-SIG TS 5G.213 v1.9 is reproduced as FIG. 16]

### 8.4.3.2 BRRS-RI Definition

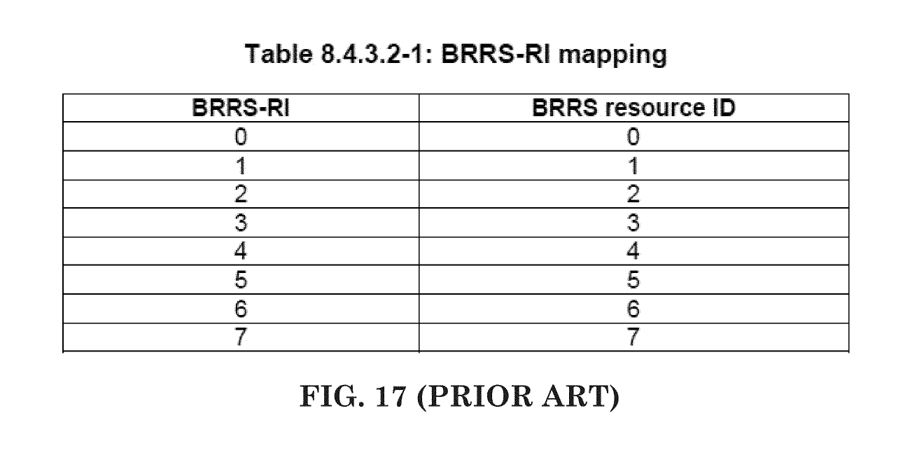

BRRS-RI indicates a selected BRRS resource ID. A BR process may comprise of a maximum of 8 BRRS resource IDs. The selected BRRS resource ID is indicated by 3 bits as in Table 8.4.3.2-1.

[Table 8.4.3.2-1, entitled “BRRS-RI mapping”, of KT 5G-SIG TS 5G.213 v1.9 is reproduced as FIG. 17]

Beamforming management in L2 layer is described in KT 5G-SIG TS 5G.321 as follows:

### 5.5 Beam Management

### 5.5.1 Beam Feedback Procedure

The beam feedback procedure is used to report beam measurement results to the serving cell.

There are two beam feedback procedures defined one based on measurement of beam reference signal (BRS), beam

state information reporting below, and one based on measurement of beam refinement reference signal (BRRS), beam

refinement information reporting below.

### 5.5.1.1 Beam State Information Reporting

The BRS-based beam state information (BSI) reports initiated by xPDCCH order are transmitted through UCI on

xPUCCH/xPUSCH as scheduled by the corresponding DCI[1]; event triggered BSI reports are transmitted through BSI

Feedback MAC Control Element defined in subclause 6.1.3.11 using normal SR or contention-based RACH procedure,

where BSI consists of Beam Index (BI) and beam reference signal received power (BRSRP). BSI reports are based on BRS transmitted by the serving cell.

5.5.1.1.1 BSI Reporting Initiated by xPDCCH Order

The BSI reports initiated by xPDCCH order are based on the latest measurement results obtained from the 5G physical

layer.

```
- if an xPDCCH order which requests BSI reporting through UCI via xPUCCH by serving cell is
  received in this TTI:
    - if the serving beam is not the best beam and the BRSRP of the best beam is higher
than BRSRP of the serving beam:
        - instruct the 5G physical layer to signal the best beam on the scheduled UCI
    resource via xPUCCH as defined in [1];
    - else:
        - instruct the 5G physical layer to signal the serving beam on the scheduled UCI
    resource via xPUCCH as defined in [1];
- if an xPDCCH order which requests BSI reporting through UCI via xPUSCH by serving cell is
  received in this TTI:
    - if the number of BSI for reports requested equals to 1:
        - if the serving beam is not the best beam and the BRSRP of the best beam is
        higher than BRSRP of the serving beam:
            - instruct the 5G physical layer to signal the best beam on the scheduled UCI
        resource via xPUSCH as defined in [1];
        - else:
            - instruct the 5G physical layer to signal the serving beam on the scheduled
          UCI resource via PUSCH as defined in [1];
    - else if the number of BSI reports requested is higher than 1 and:
        - if the serving beam is not the best beam and the BRSRP of the best beam is
        higher than BRSRP of the serving beam:
        - instruct the 5G physical layer to signal N BSIs report withthe best beam as
        the first BSI and the next N−1 highest BRSRP beam values on the scheduled
        UCI resource via xPUSCH;
    - else:
        - instruct the 5G physical layer to signal N BSIs report with the serving beam
        as the first BSI and the next N−1 highest BRSRP beam values on the
        scheduled UCI resource via xPUSCH;
```

### 5.5.1.1.2 BSI Reporting Initiated by 5G-MAC

The BSI reports initiated by 5G-MAC are based on an event trigger.

```
- if the BRSRP of the best beam is higher than beamTriggeringRSRPoffset
dB + the BRSRP of the serving beam
and:
    - if the UE is uplink synchoronized (i.e., timeAlignment Timer
    is not expired)
        - UE transmits BSI Feedback MAC Control Element on the
    UL resource granted through normal SR procedure;
    - else:
        - UE transmits BSI Feedback MAC Control Element on the UL
    resource for Msg3 granted through contention-based random
    access procedure;
```

In RAN1 #89 meeting and NR Ad-Hoc#2 meeting in June 2017, there are some agreements about multi-TRP transmission, as discussed in 3GPP R1-1709881 and Draft_Minutes_report_RAN1#AH_NR2_v010 as follows:
Adopt the following for NR reception:
   Single NR-PDCCH schedules single NR-PDSCH where separate layers are transmitted from separate TRPs
   Multiple NR-PDCCHs each scheduling a respective NR-PDSCH where each NR-PDSCH is transmitted from a separate TRP
   Note: the case of single NR-PDCCH schedules single NR-PDSCH where each layer is transmitted from all TRPs jointly can be done in a spec-transparent manner
      Note: CSI feedback details for the above case can be discussed separately [symbol]
The maximum supported number of unicast and dynamically scheduled NR-PDSCHs a UE can be expected to simultaneously receive is 2 on a per component carrier basis in case of one bandwidth part for the component carrier
   FFS in case of two or more bandwidth parts for the component carrier
   FFS the max number of corresponding NR-PDCCHs

In LTE/LTE-A, the TDD HARQ-ACK feedback procedures are described in 3GPP TS 36.212 as follows:

### 10.1.3 TDD HARQ-ACK Feedback Procedures

For TDD and a UE that does not support aggregating more than one serving cell with frame structure type 2, two HARQ-ACK feedback modes are supported by higher layer configuration.
HARQ-AC
K bundling and
HARQ-ACK multiplexing

For TDD and a BL/CE UE,
if the UE is configured with csi-NumRepetitionCE equal to 1 and mPDCCH-NumRepetition equal to 1,
   the UE may be configured with HARQ-ACK bundling or HARQ-ACK multiplexing;
   HARQ-ACK multiplexing can be configured only if pucch-NumRepetitionCE-format1 equal 1 and HARQ-ACK multiplexing is performed according to the set of Tables 10.1.3-5/6/7
else
   the UE is not expected to receive more than one PDSCH transmission, or more than one of PDSCH and MPDCCH indicating downlink SPS releases, with transmission ending within subframe(s) n-k, where k∈K and K is defined in Table 10.1.3.1-1 intended for the UE;

For TDD UL/DL configuration 5 and a UE that does not support aggregating more than one serving cell with frame structure type 2 and the UE is not configured with EIMTA-MainConfigServCell-r12 for the serving cell, only HARQ-ACK bundling is supported.

A UE that supports aggregating more than one serving cell with frame structure type 2 is configured by higher layers to use either PUCCH format 1b with channel selection or PUCCH format 3/4/5 for transmission of HARQ-ACK when configured with more than one serving cell with frame structure type 2.

A UE that supports aggregating more than one serving cell with frame structure type 2 and is not configured with the parameter EIMTA-MainConfigServCell-r12 for any serving cell is configured by higher layers to use HARQ-ACK bundling, PUCCH format 1b with channel selection according to the set of Tables 10.1.3-2/3/4 or according to the set of Tables 10.1.3-5/6/7, or PUCCH format 3 for transmission of HARQ-ACK when configured with one serving cell with frame structure type 2.

A UE that is configured with the parameter EIMTA-MainConfigServCell-r12 and configured with one serving cell is configured by higher layers to use PUCCH format 1b with channel selection according to the set of Tables 10.1.3-5/6/7, or PUCCH format 3 for transmission of HARQ-ACK. A UE that is configured with the parameter EIMTA-MainConfigServCell-r12 for at least one serving cell and configured with more than one serving cell is configured by higher layers to use PUCCH format 1b with channel selection according to the set of Tables 10.1.3-5/6/7, or PUCCH format 3/4/5 for transmission of HARQ-ACK.

PUCCH format 1b with channel selection according to the set of Tables 10.1.3-2/3/4 or according to the set of Tables 10.1.3-5/6/7 is not supported for TDD UL/DL configuration 5.

TDD HARQ-ACK bundling is performed per codeword across M multiple downlink or special subframes associated with a single UL subframe n, where M is the number of elements in the set K defined in Table 10.1.3.1-1, by a logical AND operation of all the individual PDSCH transmission (with and without corresponding PDCCH/EPDCCH/MPDCCH) HARQ-ACKs and ACK in response to PDCCH/EPDCCH/MPDCCH indicating downlink SPS release. For one configured serving cell the bundled 1 or 2 HARQ-ACK bits are transmitted using PUCCH format 1a or PUCCH format 1b, respectively.

For TDD HARQ-ACK multiplexing and a subframe n with M>1, where M is the number of elements in the set K defined in Table 10.1.3.1-1, spatial HARQ-ACK bundling across multiple codewords within a downlink or special subframe is performed by a logical AND operation of all the corresponding individual HARQ-ACKs. PUCCH format 1b with channel selection is used in case of one configured serving cell. For TDD HARQ-ACK multiplexing and a subframe n with M=1, spatial HARQ-ACK bundling across multiple codewords within a downlink or special subframe is not performed, 1 or 2 HARQ-ACK bits are transmitted using PUCCH format 1a or PUCCH format 1b, respectively for one configured serving cell.

In the case of TDD and more than one configured serving cell with PUCCH format 1b with channel selection and more than 4 HARQ-ACK bits for M multiple downlink or special subframes associated with a single UL subframe n, where M is defined in Subclause 10.1.3.2.1, and for the configured serving cells, spatial HARQ-ACK bundling across multiple codewords within a downlink or special subframe for all configured cells is performed and the bundled HARQ-ACK bits for each configured serving cell is transmitted using PUCCH format 1b with channel selection. For TDD and more than one configured serving cell with PUCCH format 1b with channel selection and up to 4 HARQ-ACK bits form multiple downlink or special subframes associated with a single UL subframe n, where m is defined in Subclause 10.1.3.2.1, and for the configured serving cells, spatial HARQ-ACK bundling is not performed and the HARQ-ACK bits are transmitted using PUCCH format 1b with channel selection.

In the case of TDD and more than one configured serving cell with PUCCH format 3 and without PUCCH format 4/5 configured and more than 20 HARQ-ACK bits for M multiple downlink or special subframes associated with a single UL subframe n, where m is the number of elements in the set K defined in Subclause 10.1.3.2.2 and for the configured serving cells, spatial HARQ-ACK bundling across multiple codewords within a downlink or special subframe is performed for each serving cell by a logical AND operation of all of the corresponding individual HARQ-ACKs and PUCCH format 3 is used. For TDD and more than one configured serving cell with PUCCH format 3 and up to 20 HARQ-ACK bits for M multiple downlink or special subframes associated with a single UL subframe n, where m is the number of elements in the set K defined in Subclause 10.1.3.2.2 and for the configured serving cells, spatial HARQ-ACK bundling is not performed and the HARQ-ACK bits are transmitted using PUCCH format 3.

For TDD with PUCCH format 3 without PUCCH format 4/5 configured, a UE shall determine the number of HARQ-ACK bits, o, associated with an UL subframe n according to

$$O = {\sum }_{c = 1}^{{N}_{cells}^{DL}} {O}_{c}^{ACK}$$

where N_{cells}^{DL} is the number of configured cells, and O_{c}^{ACK} is the number of HARQ-bits for the c-th serving cell defined in Subclause 7.3.

TDD HARQ-ACK feedback procedures for one configured serving cell are given in Subclause 10.1.3.1 and procedures for more than one configured serving cell are given in Subclause 10.1.3.2.

[symbol]

### 10.1.3A FDD-TDD HARQ-ACK Feedback Procedures for Primary Cell Frame Structure Type 2

A UE is configured by higher layers to use either PUCCH format 1b with channel selection or PUCCH format 3/4/5 for transmission of HARQ-ACK.

For a serving cell, if the serving cell is frame structure type 1, and a UE is not configured to monitor PDCCH/EPDCCH in another serving cell for scheduling the serving cell, set K is defined in Table 10.1.3A-1, otherwise set K is defined in Table 10.1.3.1-1.

PUCCH format 1b with channel selection is not supported if a UE is configured with more than two serving cells, or if the DL-reference UL/DL configuration 5 (as defined in Subclause 10.2) is defined for any serving cell, or if the DL-reference UL/DL configuration of a serving cell with frame structure type 1 belongs to {2, 3, 4} and the UE is not configured to monitor PDCCH/EPDCCH in another serving cell for scheduling the serving cell.

If a UE is configured with the parameter EIMTA-MainConfigServCell-r12 for at least one serving cell and is configured with PUCCH format 3 without PUCCH format 4/5 configured, the UE is not expected to be configured with more than two serving cells having DL-reference UL/DL configuration 5.

If a UE is configured to use PUCCH format 1b with channel selection for HARQ-ACK transmission, for the serving cells,
if more than 4 HARQ-ACK bits for M multiple downlink and special subframes associated with a single UL subframe n, where M is as defined in Subclause 10.1.3.2.1 for case where the UE is configured with two serving cells with different UL/DL configurations,
   spatial HARQ-ACK bundling across multiple codewords within a downlink or special subframe is performed for each serving cell by a logical AND operation of all the corresponding individual HARQ-ACKs, and the bundled HARQ-ACK bits for each serving cell is transmitted using PUCCH format 1b with channel selection,
otherwise,
   spatial HARQ-ACK bundling is not performed, and the HARQ-ACK bits are transmitted using PUCCH format 1b with channel selection.

If a UE is configured to use PUCCH format 3 without PUCCH format 4/5 configured for HARQ-ACK transmission, for the serving cells,
if more than 21 HARQ-ACK bits for M multiple downlink and special subframes associated with a single UL subframe n, where M as defined in Subclause 10.1.3.2.2 for the case of UE configured with more than one serving cell and if at least two cells have different UL/DL configurations,
   spatial HARQ-ACK bundling across multiple codewords within a downlink or special subframe is performed for each serving cell by a logical AND operation of all of the corresponding individual HARQ-ACKs, and PUCCH format 3 is used,
otherwise,
   spatial HARQ-ACK bundling is not performed, and the HARQ-ACK bits are transmitted using PUCCH format 3.
UE shall determine the number of HARQ-ACK bits, o, associated with an UL subframe n according to

$$O = {\sum }_{c = 1}^{{N}_{cells}^{DL}} {O}_{c}^{ACK}$$

where N_{cells}^{DL} is the number of configured cells, and O_{c}^{ACK} is the number of HARQ-bits for the c-th serving cell defined in Subclause 7.3.4. If a UE is not configured to monitor PDCCH/EPDCCH in another serving cell for scheduling a serving cell with frame structure type 1, and the DL-reference UL/DL configuration of the serving cell belongs to {2, 3, 4, 5}, then the UE is not expected to be configured with N_{cells}^{DL} which result in O>21.

HARQ-ACK transmission on two antenna ports (p∈[p₀,p₁]) is supported for PUCCH format 3.

HARQ-ACK transmission on two antenna ports (p∈[p₀,p₁]) is supported for PUCCH format 1b with channel selection and with two configured serving cells.

The FDD-TDD HARQ-ACK feedback procedure for PUCCH format 1b with channel selection follows the HARQ-ACK procedure described in Subclause 10.1.3.2.1 for the case of UE configured with two serving cells with different UL/DL configurations, and for PUCCH format 3/4/5 follows the HARQ-ACK procedure described in Subclause 10.1.3.2.2/10.1.3.2.3/10.2.3.2.4 for the case of UE configured with more than one serving cell and if at least two cells have different UL/DL configurations.

Some or all of the following terminology and assumption may be used hereafter.
BS: A network central unit or a network node in NR which is used to control one or multiple TRPs which are associated with one or multiple cells. Communication between BS and TRP(s) is via fronthaul. BS could also be referred to as central unit (CU), eNB, gNB, or NodeB.
TRP: A transmission and reception point provides network coverage and directly communicates with UEs. TRP could also be referred to as distributed unit (DU) or network node.
Cell: A cell is composed of one or multiple associated TRPs, i.e. coverage of the cell is composed of coverage of all associated TRP(s). One cell is controlled by one BS. Cell could also be referred to as TRP group (TRPG).
Beam sweeping: In order to cover all possible directions for transmission and/or reception, a number of beams is required. Since it is not possible to generate all these beams concurrently, beam sweeping means to generate a subset of these beams in one time interval and change generated beam(s) in other time interval(s), i.e. changing beam in time domain. So, all possible directions can be covered after several time intervals.
Beam sweeping number: A necessary number of time interval(s) to sweep beams in all possible directions once for transmission and/or reception. In other words, a signaling applying beam sweeping would be transmitted “beam sweeping number” of times within one time period, e.g. the signaling is transmitted in (at least partially) different beam(s) in different times of the time period.
Serving beam: A serving beam for a UE is a beam generated by a network node, e.g. TRP, which is currently used to communicate with the UE, e.g. for transmission and/or reception.
Candidate beam: A candidate beam for a UE is a candidate of a serving beam. Serving beam may or may not be candidate beam.
Qualified beam: A qualified beam is a beam with radio quality, based on measuring signal on the beam, better than a threshold.
The best serving beam: The serving beam with the best quality (e.g. the highest BRSRP value).
The worst serving beam: The serving beam with the worst quality (e.g. the worst BRSRP value).

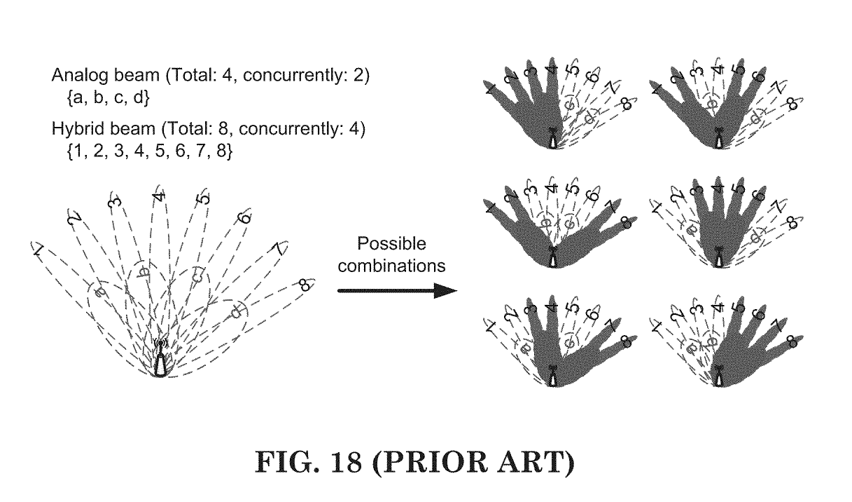

For network side:
NR using beamforming could be standalone, i.e. UE can directly camp on or connect to NR.
   NR using beamforming and NR not using beamforming could coexist, e.g. in different cells.
TRP would apply beamforming to both data and control signaling transmissions and receptions, if possible and beneficial.
   Number of beams generated concurrently by TRP depends on TRP capability, e.g. maximum number of beams generated concurrently by different TRPs may be different.
   Beam sweeping is necessary, e.g. for the control signaling to be provided in every direction.
   (For hybrid beamforming) TRP may not support all beam combinations, e.g. some beams could not be generated concurrently. FIG. 18 shows an example for combination limitation of beam generation.
Downlink timing of TRPs in the same cell are synchronized.
RRC layer of network side is in BS.
TRP should support both UEs with UE beamforming and UEs without UE beamforming, e.g. due to different UE capabilities or UE releases.

For UE side:
UE may perform beamforming for reception and/or transmission, if possible and beneficial.
   Number of beams generated concurrently by UE depends on UE capability, e.g. generating more than one beam is possible.
   Beam(s) generated by UE is wider than beam(s) generated by TRP, gNB, or eNB.
   Beam sweeping for transmission and/or reception is generally not necessary for user data but may be necessary for other signaling, e.g. to perform measurement.
   (For hybrid beamforming) UE may not support all beam combinations, e.g. some beams could not be generated concurrently. FIG. 18 shows an example for combination limitation of beam generation.
Not every UE supports UE beamforming, e.g. due to UE capability or UE beamforming is not supported in NR first (few) release(s).
One UE is possible to generate multiple UE beams concurrently and to be served by multiple serving beams from one or multiple TRPs of the same cell.
   Same or different (DL or UL) data could be transmitted on the same radio resource via different beams for diversity or throughput gain.
There are at least two UE (RRC) states: connected state (or called active state) and non-connected state (or called inactive state or idle state). Inactive state may be an additional state or belong to connected state or non-connected state.

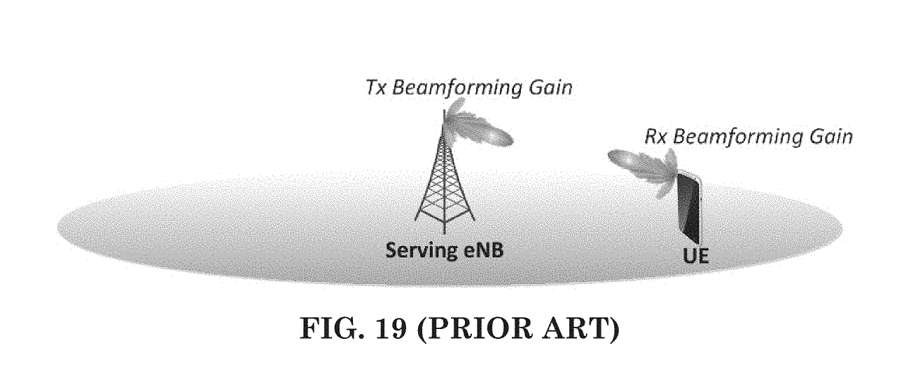

Based on 3GPP R2-162251, to practically use beamforming in both eNB and UE sides, antenna gain by beamforming in eNB is considered about 15 to 30 dBi and the antenna gain of UE is considered about 3 to 20 dBi. FIG. 19 (reproduced from 3GPP R2-162251) illustrates gain compensation by beamforming.

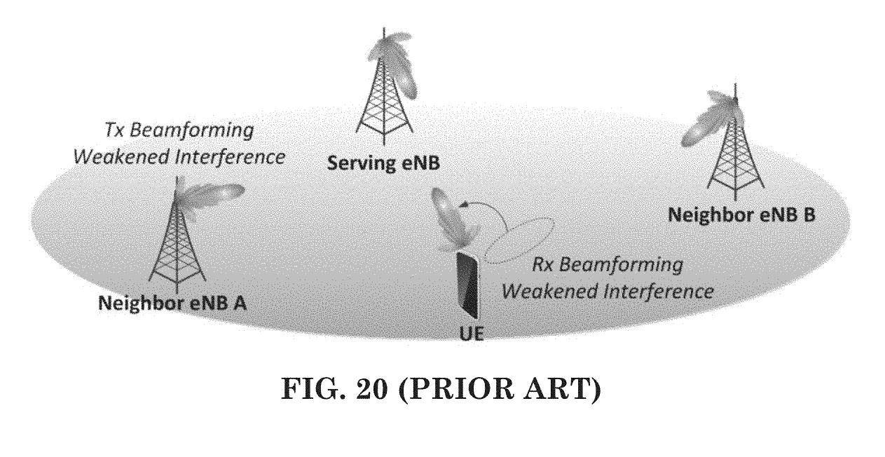

From the SINR perspective, sharp beamforming reduces interference power from neighbor interferers, i.e. neighbor eNBs in downlink case or other UEs connected to neighbor eNBs. In TX (Transmission) beamforming case, only interference from other TXs whose current beam points the same direction to the RX will be the “effective” interference. The “effective” interference means that the interference power is higher than the effective noise power. In RX beamforming case, only interference from other TXs whose beam direction is the same to the UE's current RX (Reception) beam direction will be the effective interference. FIG. 20 (reproduced from 3GPP R2-162251) illustrates weakened interference by beamforming.

Issue and Solution:

In LTE/LTE-A, spatial HARQ-ACK (HARQ Acknowledgement) bundling across multiple codewords within a downlink or special subframe is performed by a logical AND operation in case that PUCCH (Physical Uplink Control Channel) transmission in single UL (Uplink) subframe cannot accommodate all individual HARQ-ACKs of associated multiple downlink or special subframes.

For example, for TDD (Time Division Duplex) HARQ-ACK multiplexing and a single UL subframe with more than one associated downlink or special subframes, spatial HARQ-ACK bundling across multiple codewords within a downlink or special subframe is performed by a logical AND operation of all the corresponding individual HARQ-ACKs. PUCCH format 1b with channel selection is used in case of one configured serving cell.

As another example, in the case of TDD and more than one configured serving cell with PUCCH format 1b with channel selection and more than 4 HARQ-ACK bits for multiple downlink or special subframes associated with a single UL subframe and for the configured serving cells, spatial HARQ-ACK bundling across multiple codewords within a downlink or special subframe for all configured cells is performed and the bundled HARQ-ACK bits for each configured serving cell is transmitted using PUCCH format 1b with channel selection.

As an additional example, in the case of TDD and more than one configured serving cell with PUCCH format 3 and more than 20 HARQ-ACK bits for multiple downlink or special subframes associated with a single UL subframe and for the configured serving cells, spatial HARQ-ACK bundling across multiple codewords within a downlink or special subframe is performed for each serving cell by a logical AND operation of all of the corresponding individual HARQ-ACKs and PUCCH format 3 is used.

In LTE/LTE-A, the spatial HARQ-ACK bundling means that HARQ-ACK bits of multiple codewords within a subframe in one cell are performed by a logical AND operation. If the HARQ-ACK bits are all ACK, the bundled result is one bit for ACK. Otherwise, the bundled result is one bit for NACK. Once the network receives NACK bit, the network cannot know which codeword(s) are not successfully received by UE. The possible way for network may be retransmit all these codewords for the UE. Considering the impact due to HARQ-ACK bundling, it would be more reasonable to bundling codewords with higher relationship. Thus, spatial HARQ-ACK bundling is firstly performed rather than timely HARQ-ACK bundling and inter-cell HARQ-ACK bundling.

As shown in the NR (New Radio) background, multiple TRPs may serve a UE for DL data transmission. A UE may receive single DL (Downlink) control transmission which schedules single DL data transmission where separate layers are transmitted from separate TRPs. Or a UE may receive multiple DL control transmissions each scheduling a respective DL data transmission where each DL data transmission is transmitted from a separate TRP. The downlink control transmission may be NR-PDCCH (New Radio Physical Downlink Control Channel), and the DL data transmission may be NR-PDSCH (New Radio Physical Downlink Shared Channel). After receiving DL control transmission and/or DL data transmission, the UE may feedback HARQ-ACK to network. Network can perform the DL data re-transmission if the UE does not receive the DL data transmission successfully. For the multiple TRP transmission, since the DL data transmissions are transmitted from different TRPs, it requires some consideration for UE to feedback HARQ-ACK.

The main consideration for multiple TRP transmission is that the channel between TRP and UE will be quite different for respective TRP. Thus, it is not proper to bundle the HARQ-ACK bits for DL data transmission(s) through different TRP-to-UE channels. More specifically, if per-layer(s) HARQ-ACK feedback is supported, spatial HARQ-ACK bundling is not properly performed for a DL data transmission where separate layers of the DL data transmission are transmitted from separate TRPs. Furthermore, spatial HARQ-ACK bundling is not properly performed for a DL data transmission where separate codewords of the DL data transmission are transmitted from separate TRPs. In addition, HARQ-ACK bundling is not properly performed for multiple DL data transmissions where each DL data transmission is transmitted from respective TRP.

Assuming that a UE receives a DL transmission in a TTI (Transmission Time Interval) in one serving cell, the UE generates at least two feedback bits associated to separate layers of the DL transmission. The feedback bit is to indicate whether the UE receives the associated DL transmission successfully or not. The feedback bits may be HARQ-ACK bits. When the UE performs bundling, the UE performs bundling at least across the two feedback bits if the separate layers of the DL transmission are transmitted at least from the same TRP. When the UE performs bundling, the UE cannot perform bundling at least across the two feedback bits if the separate layers of the DL transmission are transmitted from separate TRPs. More specifically, the UE performs bundling across feedback bits for multiple DL transmissions in multiple TTIs if separate layers of the multiple DL transmissions are transmitted from separate TRPs.

In one embodiment, the UE performs bundling across feedback bits for multiple DL transmissions in multiple TTIs wherein the feedback bits are associated to the layers of multiple DL transmissions transmitted from the same TRP in multiple TTIs. The UE cannot perform bundling across feedback bits for multiple DL transmissions in multiple TTIs if the feedback bits are associated to the layers of multiple DL transmissions which are transmitted from different TRPs in different TTIs. In one embodiment, the UE performs bundling across feedback bits for multiple DL transmissions in two TTIs if separate layers of the multiple DL transmissions are transmitted from separate TRPs.

In one embodiment, whether the separate layers of the DL transmission are transmitted from separate TRPs or from the same TRP may be indicated by control signaling. More specifically, whether the separate layers of the DL transmission are transmitted from separate TRPs or from the same TRP may be indicated by QCL assumption between the layers of DL transmission and reference signal resource or by QCL assumption between the layers of DL transmission and reference signal port. Alternatively, whether the separate layers of the DL transmission are transmitted from separate TRPs or from the same TRP may be indicated by MAC. Alternatively, whether the separate layers of the DL transmission are transmitted from separate TRPs or from the same TRP may be configured by higher layer.

In one embodiment, the UE feedbacks separate HARQ-ACK bits for respective layer or respective layers. The DL data layer(s) transmitted from separate TRPs are mapped to separate layer or separate layers. In one embodiment, a layer group or a layer mapping may be set to indicate the association between the feedback bits and the layers of the DL transmission. Then, the UE feedbacks separate feedback bits for respective layer group. The layers of the DL data transmitted from separate TRPs are mapped to separate layer group.

In one embodiment, the layer group or the layer mapping may be specified or configured by higher layer or indicated by control signal or MAC (Medium Access Control). In one embodiment, the UE performs bundling across feedback bits for multiple DL transmissions in multiple TTIs wherein the feedback bits are associated to the same layer group or the same layer mapping for the multiple DL transmissions in multiple TTIs. In one embodiment, the UE does not perform bundling across feedback bits for multiple DL transmissions in multiple TTIs if the feedback bits are not associated to the same layer group or the same layer mapping for the multiple DL transmissions in multiple TTIs. More specifically, the UE does not perform bundling across feedback bits for multiple DL transmissions in multiple TTIs if the feedback bits are associated to different layer group or different layer mapping for the multiple DL transmissions in different TTIs.

In one embodiment, the DL data layers transmitted from the same TRP are mapped to one codeword of the DL transmission. The DL data layers transmitted from different TRPs are mapped to different codewords of the DL transmission. Single DL transmission may comprise at most two codewords. Then, the UE generates separate feedback bits for respective codeword. The DL transmission transmitted from separate TRPs is mapped to separate codewords.

In one embodiment, the mapping between layers and codeword of the DL transmission may be specified or configured by higher layer or indicated by control signal or MAC. In one embodiment, the UE performs bundling across feedback bits for multiple DL transmissions in multiple TTIs wherein the feedback bits are associated to the same index of codeword for the multiple DL transmissions in multiple TTIs. In one embodiment, the UE does not perform bundling across feedback bits for multiple DL transmissions in multiple TTIs if the feedback bits are not associated to the same index of codeword for the multiple DL transmissions in multiple TTIs. In one embodiment, the UE does not perform bundling across feedback bits for multiple DL transmissions in multiple TTIs if the feedback bits are associated to different index of codeword for the multiple DL transmissions in different TTIs.

The UE may transmit a UL transmission in a TTI to deliver information of multiple feedback bits. More specifically, the multiple feedback bits are associated to multiple DL transmissions in multiple TTIs in one serving cell. Alternatively, the multiple feedback bits are associated to multiple DL transmissions in a TTI in multiple serving cells. Alternatively, the multiple feedback bits are associated to multiple DL transmissions in multiple TTIs in multiple serving cells. Preferably, the UE performs bundling if the UL transmission does not accommodate all the multiple feedback bits for all associated DL transmissions. The UE performs bundling to reduce all generated feedback bits to a number of bundled feedback bits wherein the bundled feedback bits are delivered or transmitted on a UL transmission.

In one embodiment, the DL transmission is NR-PDSCH. More specifically, the DL transmission is schedule by a DL control transmission. Furthermore, the DL control transmission is NR-PDCCH. In one embodiment, the UL transmission for delivering feedback bits for the DL transmission is NR-PUCCH. More specifically, the resource of the UL transmission is derived from the resource of DL control transmission or the resource of DL data transmission. Furthermore, the number of bundled feedback bits is larger than 2. In one embodiment, bundling is performed by a logical AND operation.

Assuming that a UE receives at least two DL transmissions in a TTI in one serving cell, the UE generates at least two feedback bits associated to the at least two DL transmissions respectively. More specifically, the maximum supported number of unicast and dynamically scheduled DL transmission a UE can be expected to simultaneously receive is X on a per component carrier basis in case of one bandwidth part for the component carrier. In one embodiment, X may be at least one of 2 or 3 or 4. The feedback bit is to indicate whether the UE receives the associated DL transmission successfully or not. The feedback bits may be HARQ-ACK bits. When the UE performs bundling, the UE performs bundling at least across the two feedback bits if the at least two DL transmissions are transmitted at least from the same TRP. When the UE performs bundling, the UE cannot perform bundling at least across the two feedback bits if the at least two DL transmissions are transmitted from separate TRPs.

In one embodiment, the UE performs bundling across feedback bits for multiple DL transmissions in multiple TTIs if the multiple DL transmissions are transmitted from separate TRPs. In one embodiment, the UE performs bundling across feedback bits for multiple DL transmissions in multiple TTIs wherein the feedback bits are associated to the multiple DL transmissions transmitted from the same TRP in multiple TTIs. The UE cannot performs bundling across feedback bits for multiple DL transmissions in multiple TTIs if the feedback bits are associated to the multiple DL transmissions which are transmitted from different TRPs in different TTIs. In one embodiment, the UE performs bundling across feedback bits for multiple DL transmissions in two TTIs if the multiple DL transmissions are transmitted from separate TRPs.

The multiple DL transmissions transmitted from the same TRP in multiple TTIs means that the multiple DL transmissions in multiple TTIs are QCLed with the same reference signal resource or the same reference signal port. The multiple DL transmissions transmitted from different TRPs in different TTIs means that the multiple DL transmissions in different TTIs are QCLed with different reference signal resource or different reference signal port.

In one embodiment, whether the at least two DL transmissions are transmitted from separate TRPs or from the same TRP is indicated by control signaling. More specifically, whether the at least two DL transmissions are transmitted from separate TRPs or from the same TRP is indicated by QCL assumption between the DL transmission and reference signal resource or by QCL assumption between the DL transmission and reference signal port. Alternatively, whether the at least two DL transmissions are transmitted from separate TRPs or from the same TRP is indicated by MAC. Alternatively, whether the at least two DL transmissions are transmitted from separate TRPs or from the same TRP is configured by higher layer.

The UE may transmit a UL transmission in a TTI to deliver information of multiple feedback bits. More specifically, the multiple feedback bits are associated to multiple DL transmissions in multiple TTIs in one serving cell. Alternatively, the multiple feedback bits are associated to multiple DL transmissions in a TTI in multiple serving cells. Alternatively, the multiple feedback bits are associated to multiple DL transmissions in multiple TTIs in multiple serving cells. In one embodiment, the UE performs bundling if the UL transmission does not accommodate all the multiple feedback bits for all associated DL transmissions. The UE performs bundling to reduce all generated feedback bits to a number of bundled feedback bits wherein the bundled feedback bits are delivered or transmitted on a UL transmission.

In one embodiment, the DL transmission is NR-PDSCH. More specifically, the DL transmission is schedule by a DL control transmission. Furthermore, the DL control transmission is NR-PDCCH. In one embodiment, the UL transmission for delivering feedback bits for the DL transmission is NR-PUCCH. More specifically, the resource of the UL transmission is derived from the resource of DL control transmission or the resource of DL data transmission. Furthermore, if the UE receives at least two DL control transmissions, which schedules at least two DL transmissions respectively, in a TTI in one serving cell, the resource of the UL transmission for delivering feedback bits for the at least two DL transmissions is derived from at least one resource of the at least two DL control transmissions or at least one resource of the at least two DL data transmission. In one embodiment, the number of bundled feedback bits is larger than 2. In one embodiment, bundling is performed by a logical AND operation.

In one embodiment, the TTI is a time unit for DL transmission. Preferably, the TTI is slot or subframe.

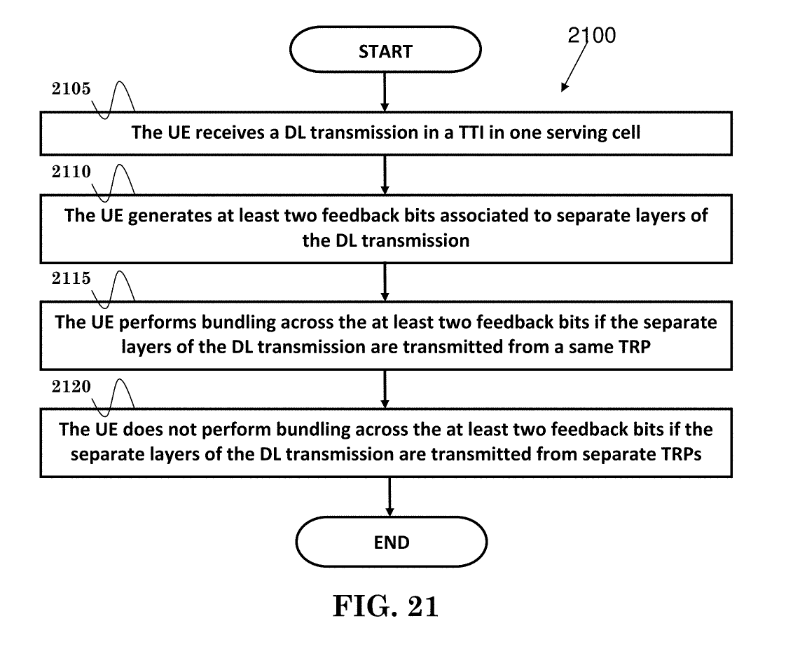

FIG. 21 is a flow chart 2100 according to one exemplary embodiment from the perspective of a UE. In step 2105, the UE receives a DL transmission in a TTI in one serving cell. In step 2110, the UE generates at least two feedback bits associated to separate layers of the DL transmission. In step 2115, the UE performs bundling across the at least two feedback bits if the separate layers of the DL transmission are transmitted from a same TRP. In step 2120, the UE does not perform bundling across the at least two feedback bits if the separate layers of the DL transmission are transmitted from separate TRPs.

In one embodiment, if the separate layers of the DL transmissions are transmitted from separate TRPs, the UE could perform bundling across feedback bits of multiple DL transmissions in multiple TTIs, wherein the feedback bits are associated to the layers of the multiple DL transmissions transmitted from the same TRP in the multiple TTIs. Furthermore, the UE may not perform bundling across feedback bits of multiple DL transmissions in multiple TTIs if the feedback bits are associated to the layers of the multiple DL transmissions which are transmitted from different TRPs in different TTIs.

In one embodiment, the separate layers of the DL transmission transmitted from the same TRP could mean that the separate layers of the DL transmission are QCLed (Quasi-colocation) with the same reference signal resource or the same reference signal port. Furthermore the separate layers of the DL transmission transmitted from separate TRPs could mean that the separate layers of the DL transmission are QCLed with separate reference signal resources or separate reference signal ports. Furthermore, whether the separate layers of the DL transmission are transmitted from separate TRPs or from the same TRP could be indicated by control signalling, indicated by MAC (Medium Access Control), or could be configured by higher layer.

In one embodiment, wherein a layer group or a layer mapping is set to indicate the association between the at least two feedback bits and the separate layers of the DL transmission, and/or the layer group or the layer mapping could be specified or configured by higher layer, or could be indicated by control signal or MAC. In addition, the layers of the DL transmission transmitted from separate TRPs could be mapped to separate layer groups.

In one embodiment, the UE could perform bundling across feedback bits of multiple DL transmissions in multiple TTIs wherein the feedback bits are associated to the same layer group or the same layer mapping of the multiple DL transmissions in multiple TTIs. Furthermore, the UE may not perform bundling across feedback bits of multiple DL transmissions in multiple TTIs if the feedback bits are associated to different layer group or different layer mapping of the multiple DL transmissions in different TTIs. Furthermore, the UE may not perform bundling across feedback bits for multiple DL transmissions in multiple TTIs if the feedback bits are not associated to the same layer group or the same layer mapping for the multiple DL transmissions in multiple TTIs.

In one embodiment, the layers of the DL transmission from the same TRP could be mapped to one codeword of the DL transmission, and the layers of the DL transmission transmitted from separate TRPs are mapped to different codewords of the DL transmission. In addition, the UE could generate separate feedback bits for respective codeword.

In one embodiment, the UE could perform bundling across feedback bits of multiple DL transmissions in multiple TTIs wherein the feedback bits are associated to the same index of codeword of the multiple DL transmissions in multiple TTIs. Furthermore, the UE may not performs bundling across feedback bits of multiple DL transmissions in multiple TTIs if the feedback bits are associated to different indexes of codewords of the multiple DL transmissions in different TTIs. Furthermore, the UE may not perform bundling across feedback bits for multiple DL transmissions in multiple TTIs if the feedback bits are not associated to the same index of codeword for the multiple DL transmissions in multiple TTIs. In addition, the UE could perform bundling if UL transmission does not accommodate all the multiple feedback bits for all associated DL transmissions.

In one embodiment, the UE could perform bundling across feedback bits for multiple DL transmissions in multiple TTIs if separate layers of the multiple DL transmissions are transmitted from separate TRPs. Alternatively, the UE could perform bundling across feedback bits for multiple DL transmissions in multiple TTIs wherein the feedback bits are associated to the layers of multiple DL transmissions transmitted from the same TRP in multiple TTIs. In addition, the UE may not perform bundling across feedback bits for multiple DL transmissions in multiple TTIs if the feedback bits are associated to the layers of multiple DL transmissions which are transmitted from different TRPs in different TTIs.

In one embodiment, whether the separate layers of the DL transmission are transmitted from separate TRPs or from the same TRP could be indicated by QCL assumption between the layers of DL transmission and reference signal resource or by QCL assumption between the layers of DL transmission and reference signal port.

In one embodiment, a layer group or a layer mapping could be set to indicate the association between the feedback bits and the layers of the DL transmission. In addition, the layer group or the layer mapping could be specified or configured by higher layer, or could be indicated by control signal or MAC.

In one embodiment, the layers of the DL transmission transmitted from separate TRPs could be mapped to separate layer groups. In one embodiment, the UE could generate separate feedback bits for respective layer group. In one embodiment, the layers transmitted from different TRPs could be mapped to different codewords of the DL transmission. In one embodiment, the layers transmitted from same TRP could be mapped to one codeword of the DL transmission.

In one embodiment, the DL transmission could comprise two codewords. The UE could generate separate feedback bits for respective codeword.

In one embodiment, the UE could transmit a UL transmission in a TTI to deliver information of multiple feedback bits. The multiple feedback bits could be associated to multiple DL transmissions in multiple TTIs in one serving cell or in multiple serving cells. The multiple feedback bits could also be associated to multiple DL transmissions in multiple TTIs in multiple serving cells.

In one embodiment, the UE could perform bundling to reduce all generated feedback bits to a number of bundled feedback bits wherein the bundled feedback bits are delivered or transmitted on a UL transmission. In one embodiment, the number of bundled feedback bits could be larger than 2. The bundling could be performed by a logical AND operation.

In one embodiment, the feedback bit could indicate whether the UE receives the associated DL transmission successfully or not. The feedback bit could be HARQ-ACK bit. The DL transmission could be NR-PDSCH, and the DL transmission could be scheduled by a DL control transmission. Alternatively, the DL control transmission could be NR-PDCCH, and the UL transmission for delivering feedback bits for the DL transmission could be NR-PUCCH. The resource of the UL transmission could be derived from the resource of DL control transmission or the resource of DL data transmission.

In one embodiment, the TTI could be a slot, a subframe, or a time unit for DL transmission.

Referring back to FIGS. 3 and 4, in one exemplary embodiment of a UE, the device 300 includes a program code 312 stored in the memory 310. The CPU 308 could execute program code 312 to enable the UE (i) to receive a DL transmission in a TTI in one serving cell, (ii) to generate at least two feedback bits associated to separate layers of the DL transmission, (iii) to perform bundling across the at least two feedback bits if the separate layers of the DL transmission are transmitted from a same TRP, and (iv) to not perform bundling across the at least two feedback bits if the separate layers of the DL transmission are transmitted from separate TRPs. Furthermore, the CPU 308 can execute the program code 312 to perform all of the above-described actions and steps or others described herein.

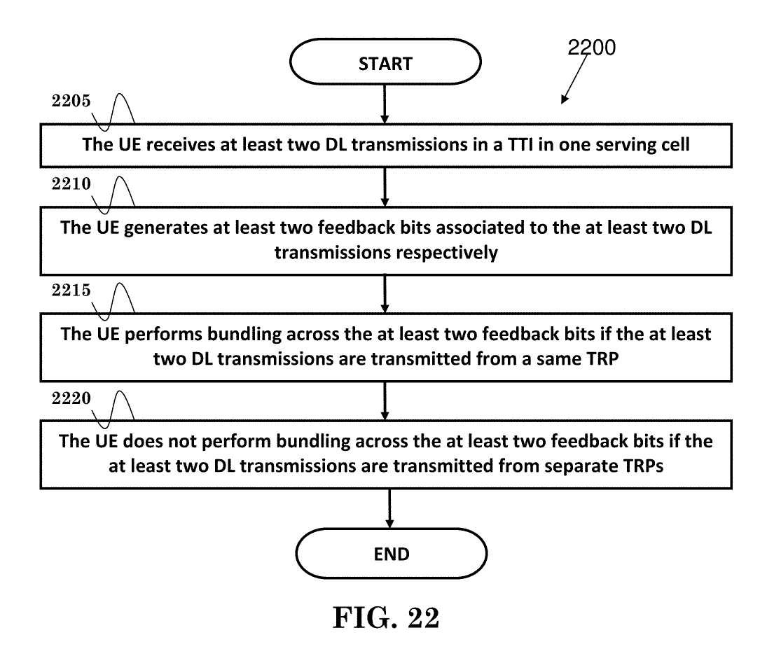

FIG. 22 is a flow chart 2200 according to one exemplary embodiment of a UE. In step 2205, the UE receives at least two DL transmissions in a TTI in one serving cell. In step 2210, the UE generates at least two feedback bits associated to the at least two DL transmissions respectively. In step 2215, the UE performs bundling across the at least two feedback bits if the at least two DL transmissions are transmitted from a same TRP. In step 2220, the UE does not perform bundling across the at least two feedback bits if the at least two DL transmissions are transmitted from separate TRPs.

In one embodiment, if the at least two DL transmissions are transmitted from separate TRPs, the UE could perform bundling across feedback bits of multiple DL transmissions in multiple TTIs wherein the feedback bits are associated to the multiple DL transmissions transmitted from the same TRP in the multiple TTIs. In addition, the UE may not perform bundling across feedback bits of multiple DL transmissions in multiple TTIs if the feedback bits are associated to the multiple DL transmissions which are transmitted from different TRPs in different TTIs.

In one embodiment, whether the at least two DL transmissions are transmitted from separate TRPs or from the same TRP could be indicated by control signalling or by MAC, or could be configured by higher layer. In one embodiment, whether the at least two DL transmissions are transmitted from separate TRPs or from the same TRP could be indicated by QCL (Quasi-colocation) assumption between the DL transmission and reference signal resource or by QCL assumption between the DL transmission and reference signal port.

In one embodiment, the at least two DL transmissions transmitted from the same TRP could mean that the at least two DL transmissions are QCLed with the same reference signal resource or the same reference signal port. Furthermore, the at least two DL transmissions transmitted from separate TRPs could mean that the at least two DL transmissions are QCLed with separate reference signal resource or separate reference signal port.

In one embodiment, if the UE receives at least two DL control transmissions which schedule the at least two DL transmissions respectively, the resource of UL transmission for delivering feedback bits for the at least two DL transmissions could be derived from at least one resource of the at least two DL control transmissions or from at least one resource of the at least two DL data transmission.

In one embodiment, the UE could perform bundling if UL transmission does not accommodate all multiple feedback bits for all associated DL transmissions.

In one embodiment, the UE may perform bundling across feedback bits for the multiple DL transmissions in multiple TTIs if the multiple DL transmissions are transmitted from separate TRPs.

In one embodiment, the multiple DL transmissions transmitted from the same TRP in multiple TTIs means that the multiple DL transmissions in multiple TTIs are QCLed with the same reference signal resource or the same reference signal port. In one embodiment, the multiple DL transmissions transmitted from different TRPs in different TTIs means that the multiple DL transmissions in different TTIs are QCLed with different reference signal resource or different reference signal port.

In one embodiment, the UE could transmit a UL transmission in a TTI to deliver information of multiple feedback bits. The multiple feedback bits could be associated to multiple DL transmissions in multiple TTIs in one serving cell, multiple DL transmissions in a TTI in multiple serving cells, or multiple DL transmissions in multiple TTIs in multiple serving cells.

In one embodiment, the UE could perform bundling to reduce all generated feedback bits to a number of bundled feedback bits wherein the bundled feedback bits are delivered or transmitted on a UL transmission. The number of bundled feedback bits could be larger than 2. The bundling could be performed by a logical AND operation.

In one embodiment, the feedback bit could indicate whether the UE receives the associated DL transmission successfully or not. The feedback bit could be a HARQ-ACK bit. The DL transmission could be NR-PDSCH, and the DL transmission could be scheduled by a DL control transmission. Alternatively, the DL control transmission could be NR-PDCCH, and the UL transmission for delivering feedback bits for the DL transmission could be NR-PUCCH.

In one embodiment, the resource of the UL transmission could be derived from the resource of DL control transmission or the resource of DL data transmission. If the UE receives at least two DL control transmissions scheduling at least two DL transmissions respectively, the resource of the UL transmission for delivering feedback bits for the at least two DL transmissions could be derived from at least one resource of the at least two DL control transmissions or at least one resource of the at least two DL data transmission.

In one embodiment, the TTI could be a slot, a subframe, or a time unit for DL transmission.

Referring back to FIGS. 3 and 4, in one exemplary embodiment of a UE, the device 300 includes a program code 312 stored in the memory 310. The CPU 308 could execute program code 312 to enable the UE (i) to receive at least two DL transmissions in a TTI in one serving cell, (ii) to generate at least two feedback bits associated to the at least two DL transmissions respectively, (iii) to perform bundling across the at least two feedback bits if the at least two DL transmissions are transmitted from a same TRP, and (iv) to not perform bundling across the at least two feedback bits if the at least two DL transmissions are transmitted from separate TRPs. Furthermore, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method of a User Equipment (UE), comprising:
the UE receives a DL (Downlink) transmission in a TTI (Transmission Time Interval) in one serving cell;
the UE generates at least two feedback bits associated to separate layers of the DL transmission;
the UE performs bundling across the at least two feedback bits if the separate layers of the DL transmission are transmitted from a same TRP (Transmission/Reception Point); and
the UE does not perform bundling across the at least two feedback bits if the separate layers of the DL transmission are transmitted from separate TRPs.

2. The method of claim 1, wherein if the separate layers of the DL transmissions are transmitted from separate TRPs, the UE performs bundling across feedback bits of multiple DL transmissions in multiple TTIs, wherein the feedback bits are associated to the layers of the multiple DL transmissions transmitted from the same TRP in the multiple TTIs.

3. The method of claim 1, wherein the UE does not perform bundling across feedback bits of multiple DL transmissions in multiple TTIs if the feedback bits are associated to the layers of the multiple DL transmissions which are transmitted from different TRPs in different TTIs.

4. The method of claim 1, wherein the separate layers of the DL transmission transmitted from the same TRP means that the separate layers of the DL transmission are QCLed with the same reference signal resource or the same reference signal port, and wherein the separate layers of the DL transmission transmitted from separate TRPs means that the separate layers of the DL transmission are QCLed with separate reference signal resources or separate reference signal ports.

5. The method of claim 1, wherein whether the separate layers of the DL transmission are transmitted from separate TRPs or from the same TRP is indicated by control signalling, indicated by MAC (Medium Access Control), or configured by higher layer.

6. The method of claim 1, wherein a layer group or a layer mapping is set to indicate the association between the at least two feedback bits and the separate layers of the DL transmission, and/or the layer group or the layer mapping is specified or configured by higher layer, or is indicated by control signal or MAC.

7. The method of claim 1, wherein the layers of the DL transmission transmitted from separate TRPs are mapped to separate layer groups.

8. The method of claim 1, wherein the UE performs bundling across feedback bits of multiple DL transmissions in multiple TTIs wherein the feedback bits are associated to the same layer group or the same layer mapping of the multiple DL transmissions in multiple TTIs, and wherein the UE does not perform bundling across feedback bits of multiple DL transmissions in multiple TTIs if the feedback bits are associated to different layer group or different layer mapping of the multiple DL transmissions in different TTIs.

9. The method of claim 1, wherein the layers of the DL transmission from the same TRP are mapped to one codeword of the DL transmission, and the layers of the DL transmission transmitted from separate TRPs are mapped to different codewords of the DL transmission.

10. The method of claim 1, wherein the UE generates separate feedback bits for respective codeword.

11. The method of claim 1, wherein the UE performs bundling across feedback bits of multiple DL transmissions in multiple TTIs wherein the feedback bits are associated to the same index of codeword of the multiple DL transmissions in multiple TTIs, and wherein the UE does not perform bundling across feedback bits of multiple DL transmissions in multiple TTIs if the feedback bits are associated to different indexes of codewords of the multiple DL transmissions in different TTIs.

12. The method of claim 1, wherein the UE performs bundling if UL transmission does not accommodate all the multiple feedback bits for all associated DL transmissions.

13. A method of a User Equipment (UE), comprising:
the UE receives at least two DL (Downlink) transmissions in a TTI (Transmission Time Interval) in one serving cell;
the UE generates at least two feedback bits associated to the at least two DL transmissions respectively;
the UE performs bundling across the at least two feedback bits if the at least two DL transmissions are transmitted from a same TRP (Transmission/Reception Point); and
the UE does not perform bundling across the at least two feedback bits if the at least two DL transmissions are transmitted from separate TRPs.

14. The method of claim 13, wherein if the at least two DL transmissions are transmitted from separate TRPs, the UE performs bundling across feedback bits of multiple DL transmissions in multiple TTIs wherein the feedback bits are associated to the multiple DL transmissions transmitted from the same TRP in the multiple TTIs.

15. The method of claim 13, wherein the UE does not perform bundling across feedback bits of multiple DL transmissions in multiple TTIs if the feedback bits are associated to the multiple DL transmissions which are transmitted from different TRPs in different TTIs.

16. The method of claim 13, wherein whether the at least two DL transmissions are transmitted from separate TRPs or from the same TRP is indicated by control signalling or by MAC, or is configured by higher layer.

17. The method of claim 13, wherein whether the at least two DL transmissions are transmitted from separate TRPs or from the same TRP is indicated by QCL assumption between the DL transmission and reference signal resource or by QCL assumption between the DL transmission and reference signal port.

18. The method of claim 13, wherein the at least two DL transmissions transmitted from the same TRP means that the at least two DL transmissions are QCLed with the same reference signal resource or the same reference signal port, and wherein the at least two DL transmissions transmitted from separate TRPs means that the at least two DL transmissions are QCLed with separate reference signal resource or separate reference signal port.

19. The method of claim 13, wherein if the UE receives at least two DL control transmissions which schedule the at least two DL transmissions respectively, the resource of UL transmission for delivering feedback bits for the at least two DL transmissions is derived from at least one resource of the at least two DL control transmissions or from at least one resource of the at least two DL data transmission.

20. The method of claim 13, wherein the UE performs bundling if UL transmission does not accommodate all multiple feedback bits for all associated DL transmissions.
